(19) United States
(12) Patent Application Publication
(10) Pub. No.: US 2026/0127879 A1
(43) Pub. Date: May 7, 2026

(54) SYSTEMS AND METHODS FOR IMPLEMENTING SPORTS TRACKING DATA

(71) Applicant: STATS LLC, Chicago, IL (US)

(72) Inventors: Harry HUGHES, Brisbane (AU); Michael John HORTON, Wellington (NZ); Felix Wei, Melbourne (AU); Patrick Joseph LUCEY, Chicago, IL (US)

(73) Assignee: STATS LLC, Chicago, IL (US)

(21) Appl. No.: 19/314,642

(22) Filed: Aug. 29, 2025

Related U.S. Application Data
(60) Provisional application No. 63/696,918, filed on Sep. 20, 2024.

(51) Int. Cl. G06V 20/40; G06V 40/20

(52) U.S. Cl. CPC G06V 20/42; G06V 40/23

(57) ABSTRACT

A computer implemented method for tracking one or more individuals during a sporting event, the method including: receiving, as an input, broadcast tracking data of a sporting event and labeled event data of the sporting event; performing multi-object tracking of one or more agents of the received broadcast tracking data to determine one or more vectors; inputting the labeled event data and one or more vectors into a diffusion model; and determining, using the diffusion model, one or more trajectory sequences for the one or more agents; and determining, an output, based on the one or more trajectory sequences for the one or more agents.

### CROSS-REFERENCE TO RELATED APPLICATIONS

This application claims the benefit of priority to U.S. Provisional Patent Application No. 63/696,918, filed on Sep. 20, 2024, the entirety of which is incorporated herein by reference.

### TECHNICAL FIELD

Various aspects of the present disclosure relate generally to machine learning for sports applications, in particular various aspects relate to machine learning techniques for systems and methods for downstream analysis of sports tracking data.

### BACKGROUND

With the rising popularity of sports, there is an increased desire for data relating to sports events, such as, for example, accurate granular predictions of what will occur during a sporting event. This desire extends beyond traditional statistics such as scores and win-loss records, encompassing more granular data including predictions, player analysis, simulations, animations, etc. For example, predicting how the number of passes or shots that a particular soccer player (e.g., Lionel Messi) will have in the given game (e.g., World Cup final), both prior to and during the World Cup final, can be of particular interest to members of the media, broadcast (whether on the primary feed, or a second screen experience), sportsbook, and fantasy/gamification applications. Existing solutions are unable to accurately make such predictions. In particular, existing solutions may be unable to accurately make predictions to the trajectory one or more players in a game. Furthermore, existing solutions may be unable to collect such data without invasive or expensive monitoring systems, such as GPS trackers, heart rate monitors, etc.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for tracking one or more individuals during a sporting event, the method including: receiving, as an input, broadcast tracking data of a sporting event and labeled event data of the sporting event; performing multi-object tracking of one or more agents of the received broadcast tracking data to determine one or more vectors; inputting the labeled event data and one or more vectors into a diffusion model; determining, using the diffusion model, one or more trajectory sequences for the one or more agents; and determining, an output, based on the one or more trajectory sequences for the one or more agents.

In some aspects, the techniques described herein relate to a method, further including: determining, a sequence of past events from the sporting event, the sequences corresponding to one or more plays in the sporting event.

In some aspects, the techniques described herein relate to a method, further including: determining, one or more alternative trajectory sequences for the one or more agents, the one or more alternative trajectory being trajectories of highest predicted success for the one or more agents.

In some aspects, the techniques described herein relate to a method, further including: generating, with a second machine learning model, a textual description of the broadcast tracking data and the labeled event data.

In some aspects, the techniques described herein relate to a method, wherein the broadcast tracking data and/or the labeled event data includes incomplete data of the sporting event.

In some aspects, the techniques described herein relate to a method, wherein the sporting event is soccer, football, or hockey.

In some aspects, the techniques described herein relate to a system for tracking one or more individuals during a sporting event, the system including: a non-transitory computer readable medium configured to store processor-readable instructions; and a processor operatively connected to the non-transitory computer readable medium, and configured to execute the instructions to perform operations including: receiving, as an input, broadcast tracking data of a sporting event and labeled event data of the sporting event; performing multi-object tracking of one or more agents of the received broadcast tracking data to determine one or more vectors; inputting the labeled event data and one or more vectors into a diffusion model; determining, using the diffusion model, one or more trajectory sequences for the one or more agents; and determining, an output, based on the one or more trajectory sequences for the one or more agents.

In some aspects, the techniques described herein relate to a system, further including: determining, a sequence of past events from the sporting event, the sequences corresponding to one or more plays in the sporting event.

In some aspects, the techniques described herein relate to a system, further including: determining, one or more alternative trajectory sequences for the one or more agents, the one or more alternative trajectory being trajectories of highest predicted success for the one or more agents.

In some aspects, the techniques described herein relate to a system, further including: generating, with a second machine learning model, a textual description of the broadcast tracking data and the labeled event data.

In some aspects, the techniques described herein relate to a system, wherein the broadcast tracking data and/or the labeled event data includes incomplete data of the sporting event.

In some aspects, the techniques described herein relate to a system, wherein the sporting event is soccer, football, or hockey.

In some aspects, the techniques described herein relate to a non-transitory computer readable medium configured to store processor-readable instructions, wherein when executed by a processor, the instructions perform operations including: receiving, as an input, broadcast tracking data of a sporting event and labeled event data of the sporting event; performing multi-object tracking of one or more agents of the received broadcast tracking data to determine one or more vectors; inputting the labeled event data and one or more vectors into a diffusion model; and determining, using the diffusion model, one or more trajectory sequences for the one or more agents; determining, an output, based on the one or more trajectory sequences for the one or more agents.

In some aspects, the techniques described herein relate to a non-transitory computer readable medium, further including:

determining, a sequence of past events from the sporting event, the sequences corresponding to one or more plays in the sporting event.

In some aspects, the techniques described herein relate to a non-transitory computer readable medium, further including: determining, one or more alternative trajectory sequences for the one or more agents, the one or more alternative trajectory being trajectories of highest predicted success for the one or more agents.

In some aspects, the techniques described herein relate to a non-transitory computer readable medium, wherein the one or more alternative trajectories, being the trajectory with the highest percentage chance of a particular play ending with a goal.

In some aspects, the techniques described herein relate to a non-transitory computer readable medium, further including: generating, with a second machine learning model, a textual description of the broadcast tracking data and the labeled event data.

In some aspects, the techniques described herein relate to a non-transitory computer readable medium, wherein the broadcast tracking data and/or the labeled event data includes incomplete data of the sporting event.

In some aspects, the techniques described herein relate to a non-transitory computer readable medium, wherein the sporting event is soccer, football, or hockey.

In some aspects, the techniques described herein relate to a non-transitory computer readable medium, further including: determining one or more fitness outputs for the one or more agents, the one or more fitness outputs each indicating how far a player has run throughout the sporting event.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts a block diagram of an exemplary tracking and analytics environment, according to one or more embodiments.

FIG. 2A depicts an exemplary block diagram of a system for a transformer network for generating trajectories of players, according to one or more embodiments.

FIG. 2B depicts an exemplary block diagram of a system for a spatiotemporal axial attention for generating trajectories of players, according to one or more embodiments.

FIG. 3 depicts a visualization of data received and determined by the system, according to one or more embodiments.

FIG. 4 depicts spatiotemporal axial attention as determined by a system, according to one or more embodiments.

FIG. 5 depicts tracking data being generated by diffusion, according to one or more embodiments.

FIG. 6 depicts an exemplary table output of the system's components, according to one or more embodiments.

FIG. 7A-7D depicts outputs of the system, according to one or more embodiments.

FIG. 8 depicts an exemplary flowchart of a method of performing imputations algorithms on predicted tracking data, according to one or more embodiments.

FIG. 9 depicts an exemplary flowchart for generating one or more graphics, text, audio, or a combination thereof based on the determined connections and/or associations, according to one or more embodiments.

FIG. 10 depicts a user of an exemplary client device inputting a query into a system to display a generated outcome, according to one or more embodiments.

FIGS. 11 and 12 depict exemplary trait definitions, according to one or more embodiments.

FIG. 13 depicts a list of exemplary qualifiers, according to one or more embodiments.

FIG. 14 depicts an index score for an individual player using both offensive and defensive traits, according to one or more embodiments.

FIG. 15 depicts an exemplary flowchart for generating a defensive influence score, according to one or more embodiments.

FIGS. 16A-C depict exemplary frames of a virtual representation of a video broadcast of a basketball game, according to one or more embodiments.

FIGS. 17A-B depict exemplary player cards illustrating various offensive and defensive metrics of a player, according to one or more embodiments.

FIG. 18 depicts an exemplary graphic output interface, according to one or more embodiments.

FIG. 19 depicts a flow diagram for training a machine learning model, in accordance with an aspect.

FIG. 20 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to machine learning for sports applications, in particular various aspects relate to machine learning techniques for systems and methods for downstream analysis of sports tracking data generated using transformer and/or diffusion techniques discussed herein.

The system described herein may implement imputation techniques for analyzing sports broadcast tracking data. The systems and methods may utilize spatiotemporal axial attention (e.g., by a transformer adapted specifically to process spatiotemporal data) for tracking of agents in a sporting event. The spatiotemporal axial attention techniques may be extended in a simple and principled manner to jointly process both event and tracking data. The system may include multimodal tracking, including semantic (event data) and fine-grained (tracking) streams.

According to embodiments disclosed herein, a guided diffusion model may receive as input broadcast tracking data and event data for a sporting event. The guided diffusion model may generate high-fidelity tracking data based on the received input data. The diffusion model may include an event encoder and a tracking decoder that may embed and fuse the received event and broadcast tracking data. The output embeddings may be fed to score-based diffusion models to generate trajectories of one or more players in a sporting event. The system may further perform downstream analysis of the determined tracking data including: retrieval of specific plays from the sporting event, generating alternative trajectories for the one or more agents, generating textual description of sequences of a play in a sporting event, generating fitness outputs for one or more agents, generating simulations of sporting events, generating graphics or animations related to sporting events, etc. It is appreciated that the terms “agent,” “player,” and “individual” may be used interchangeably throughout this application.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

While soccer and various aspects relating to soccer (e.g., a predicted total number of passes by a team during a game) are described in the present aspects as illustrative examples, the present aspects are not limited to such examples. For example, the present aspects can be implemented for other sports or activities, such as football, hockey, basketball, baseball, and so forth.

Soccer tracking data may be utilized for further analysis. Conventional systems may have relied on a set of cameras installed in the stadium and on humans to manually annotate player locations (e.g., at 10 frames-per-second). The data generated may have been used for measuring fitness outputs, and may have subsequently been used for tactical analysis.

Other conventional systems implement computer vision may be constrained based on limited availability of data. Such limited availability of the data hinders the use of tracking data for broader applications such as scouting and recruitment. Further, conventional computer vision tracking is limited to sets of teams (e.g., in particular leagues) and this limits analysis.

Data obtained from broadcast footage to supplement conventional systems is inherently incomplete due to several factors, such as players being out of the main camera's view, close-up shots, picture quality issues, and scenes where players obscure each other from view. Thus, these occlusions result in data not being captured via broadcast feeds, which data may have otherwise been captured from an in-venue data capture system.

The system described herein solves limitations associated with incomplete data. The systems and techniques disclosed herein may be used to predict sporting event actions such as a given player's likelihood of receiving a given pass from a teammate, scoring a goal, etc. The outputs of the system may reveal tactical insights into how sporting teams press, build-up, and/or create goal-scoring opportunities. This may be advantageous as aggregating this level of data to generate the insights may be impossible for an individual (e.g., a coach).

Individual data streams (e.g., in-venue tracking, event data, or broadcast data), on their own, may not properly describe a sporting event. Although in-venue tracking systems may generate highly accurate and complete tracking data, licensing agreements and the operational costs may mean that these systems have not scaled for a given sport. Another stream of data that may be available includes event data, which logs the sequential stream of semantic events within games. Event data may cover the majority of professional games. However, event data only captures the player events that are on-ball, missing off-ball actions (e.g., how a player positions themselves to receive a pass). As a result, the event data may be considered incomplete, and cannot be used to perform tasks that require perception of a wider array of player behaviors.

While broadcast tracking may address the limitations of in-venue tracking systems by being able to scale globally, similar to event data, it may not be a complete data stream, as discussed herein.

In one example for a given game, in the frames where passes occur, only an average of 43% of players can be visually perceived in a broadcast feed, meaning that over half the players on average are occluded. These occlusions impact the visibility of the most important agents during passes such as passers, receivers, and the ball. In the example game, in 21% of pass frames, the passer is occluded, and in 39% of pass frames, the receiver is occluded. Furthermore, the ball's small size and fast movement mean that the ball's trajectory may also be heavily occluded and/or noisy. The difficulties that occluded data poses in capturing the context around pass events may be even more acute in the case of goal-scoring opportunities. In the example game, of the passes that were made to receivers who subsequently attempted a shot, the receiver was occluded 17% of the time at the time when the pass was made. In an example, soccer may be a low-scoring game where scoring opportunities are sparse. The absence of this important context in broadcast tracking may impair the ability to perform complete and nuanced analysis.

Advantageously, the system described herein may utilize complete (e.g., imputed) tracking data generated or derived in accordance with the techniques disclosed herein, allowing for complete analysis. The imputed tracking data may provide value as it may capture and measure the behaviors of all players (on ball and off ball). For example, broadcast tracking data, alone, may be limited and/or miss aspects of the game (such as players being out of view, or complete segments). Utilizing only broadcast data, the system may not be able to measure all the possible options (such as players being open to receive the pass). The system described herein may solve this technical problem by providing a way to generate complete (e.g., imputed) tracking data and then performing complete downstream analysis (e.g., using pass reception/analysis as the use case). This method may be expanded to other tasks such as detecting different playing styles (i.e., counter attacks), different runs of players, different attributes/traits of players (pressing, overlapping player), and so forth. The system may also determine better fitness metrics from a bottom-up perspective, as the system may estimate fitness metrics from the complete tracking data and may not solely be a prediction based on the broadcast tracking as an input.

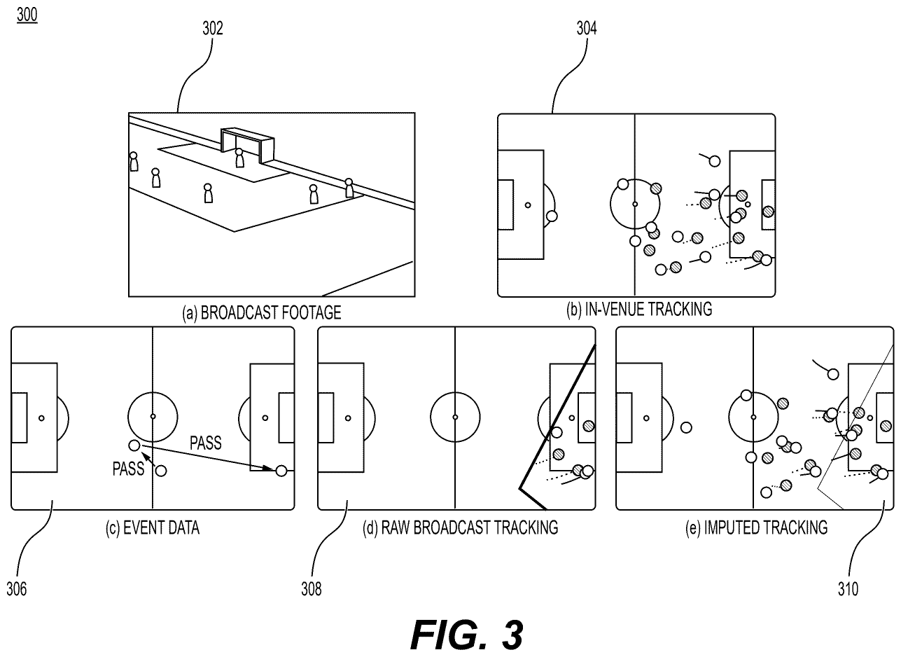

The system described herein may utilize generative Artificial Intelligence (“AI”) (e.g., diffusion models that incorporate transformers through attention mechanism) to impute highly realistic behaviors for agents (players and/or the ball) when they are occluded in broadcast tracking. These techniques and approaches described herein may generate data that is significantly more accurate as compared to incomplete raw broadcast tracking, while creating the generation of in-venue quality tracking without in-venue cameras. FIG. 3 depicts a visualization of data received and determined by the system, according to one or more embodiments. FIG. 3 depicts illustrations 300 of data that may be received as input by the system described herein such as broadcast footage 302 and event data 306. The illustration 300 may further include in-venue tracking data 304 that may be compared with the system described herein to analyze the outputs. The illustrations 300 may last include the raw broadcast tracking 308 and the imputed tracking 310, which may depict outputs of the system described herein. These may be discussed in greater detail below.

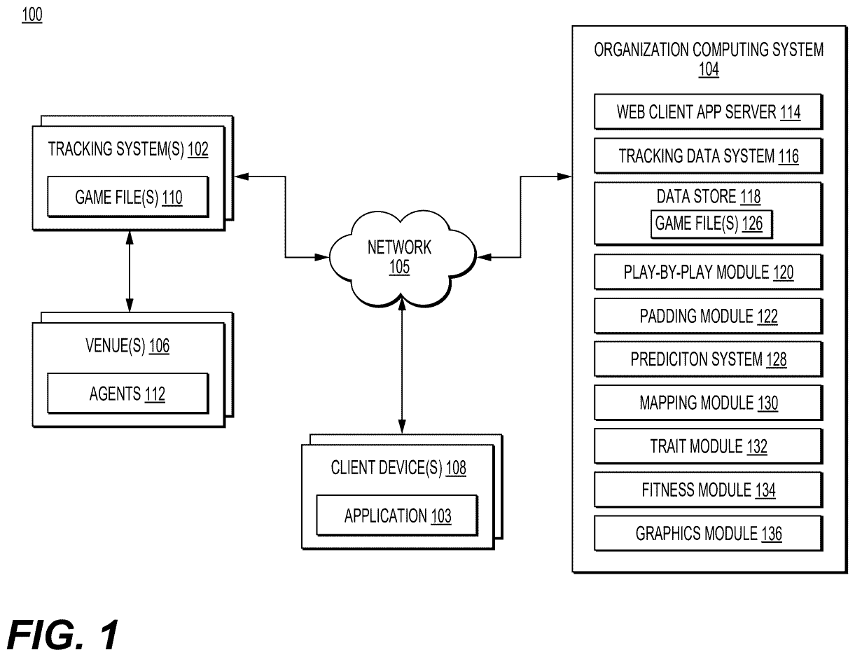

FIG. 1 is a block diagram illustrating a computing environment 100, according to example aspects of the disclosed subject matter. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models. In an example, the one or more machine learning models described herein may be configured to receive as input broadcast tracking data and event data and to perform a conditional guided diffusion to generate trajectories for one or more players in a sporting event. The one or more machine learning models may further generate outputs based on the generated trajectories for the one or more players in the sporting event, including generating alternative trajectories for the one or more players, generating fitness outputs for the one or more players, generating traits for one or more players, generating predicted events and simulations related to the one or more players, generating graphics related to the one or more players, etc.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

As an example, broadcast tracking data may include the positions (e.g., x=(x, y)) of each entity (or player) at each time step on a playing surface. Broadcast tracking data may be generated and/or stored in a format different than the format of a game file or broadcast transmission. For example, a broadcast transmission may include video files, whereas broadcast tracking data may be generated or stored as digital representations of agents and/or objects in a format different than the format of the broadcast transmission (e.g., different than a video file format). In some embodiments, to represent the broadcast tracking data in a well-defined structure that avoids issues presented in conventional approaches, a pre-processing agent may construct a graphical representation of the broadcast tracking data. For example, a pre-processing agent may construct a graph G(V,E,U) that may be defined by nodes V, edges E, and global features U. In some embodiments, each node in a graph may represent the player and ball broadcast tracking data. In some embodiments, each edge may include information about various relationships between nodes. In some embodiments, edges eij may be directed edges and connect a sending node vi to a receiving node vj.

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing broadcast tracking data (e.g., from tracking system 102), and/or one or more other data types such as a video feed, excitement data, etc. The computing system may utilize a machine learning model to determine when given broadcast tracking data or changes in broadcast tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on broadcast tracking data and/or content feeds (e.g., in-venue video feeds, broadcast feeds, etc.). For example, broadcast tracking data may be generated by providing a content feed to one or more machine learning models. The one or more machine learning models may identify players and/or objects in the content feed and convert them to digital representations. The digital representations of the players and/or objects and their respective positions may be tracked to identify broadcast tracking data such as movement data (e.g., changes in the positions), changes in movement, trends, etc. Such information may be used by a prediction module (e.g., prediction system 128) to make predictions. The tracking data may be analyzed by the machine learning models to determine correlations between the broadcast tracking data and event types (e.g., goal scored, pass made, play types, etc.). For example, broadcast tracking data may be used to determine when a digital representation of an object (e.g., a ball) crosses a scoring object (e.g., a goal post). The determination may be based on, for example, detection of a triggering change between a first broadcast tracking data digital representation and a second broadcast tracking data digital representation, where the triggering change may be for a given event type. More specifically, the determination may be made based on a component or machine learning algorithm detecting the triggering change between the first broadcast tracking data digital representation and the second broadcast tracking data digital representation, and automatically identifying correlations between the triggering change and attributes associated with one or more event types. If a correlation meets a correlation threshold for a given event type, the triggering change may be associated with the given event type, and may be tagged as event data for that event type. Such automated event data detection may be performed, for example, by a machine learning model using input data (e.g., tracking data and/or game files) that are in a non-human readable format optimized for machine learning operations. Based on such determination, for example, an event type of a goal scored may be identified based on the broadcast tracking data. Further, the digital representation of the player(s) that contacted the object (e.g., ball) prior to the goal scored event may be identified as the player(s) that contributed to or otherwise caused the event (e.g., goal). Accordingly, content feeds may be used to generate broadcast tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, prediction system 128, mapping module 130, trait module 132, fitness module 134, and/or graphics module 136. Each of tracking data system 116, play-by-play module 120, padding module 122, prediction system 124, and modules 130-136 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Data store 118 may be configured to store one or more game files 126. Each game file 126 may include video data of a given match. For example, the video data may correspond to a plurality of video frames captured by tracking system 102, the broadcast tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Tracking data system 116 may be configured to receive broadcast data from tracking system 102 and generate broadcast tracking data from the broadcast data. In some embodiments, tracking data system 116 may apply an artificial intelligence and/or computer vision system configured to derive broadcast tracking data from broadcast video feeds.

To generate the broadcast tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating broadcast tracking data from the broadcast feed (e.g., broadcast video data). For example, tracking data system 116 may perform such processes to generate broadcast tracking data across thousands of possessions and/or broadcast frames. In addition to such process, organization computing system 104 may go beyond the generation of broadcast tracking data from broadcast video data. Instead, to provide descriptive analytics, as well as a useful feature representation for prediction system 128, organization computing system 104 (via tracking data system 116) may be configured to map the tracking data to a semantic layer (e.g., events). Mapping the tracking data to a semantic layer is discussed in greater detail below.

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the broadcast tracking data, tracking data system 116 may merge or align the play-by-play data with the broadcast tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner.

For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Prediction system 128 may include a transformer neural network that may include one or more encoders and/or decoders. The transformers may be further configured to generate prediction(s) for the trajectory of one or more players during a match based on the broadcast tracking data and on the event data.

Prediction system 128 may include a diffusion model capable of generating multi-agent tracking data. Prediction system 128 may be configured to generate or simulate the remainder of a given match at the player trajectory level. For example, instead of generating trajectories for a possession, the prediction system 128 may be configured to generate trajectories for multiple possessions and even for the remainder of a sporting event. Further, the prediction system 128 may be further configured to generate event data for the game. In this manner, the prediction system 128 may be used to generate the commentary of a game via text/speech or 3D models of player behaviors. The prediction system 128 may further output data (e.g., the trajectories of the one or more players) to a mapping module 130, a trait module 132, a fitness module 134, or a graphics module 136 to perform downstream analysis of the data determined by the prediction system 128 described above.

Accordingly, downstream applications may be performed using the data output by prediction system 128, such data including data generated by and/or output via a transformer neural network and/or diffuser, as discussed herein. Such data may be considered complete (e.g., imputed) tracking data that is in a format and in a form (e.g., in a complete form that mitigates gaps in information) that can be used by such downstream applications for downstream analysis. Generation of such data represents an improvement in technology for use with downstream applications such that, for example, the quality of the downstream applications and the possibility of performing such downstream analysis is improved based on generating such data using the transformer neural network and/or diffusion techniques disclosed herein.

Mapping module 130 may be configured or trained to generate a connection and/or association with prompts of a multimodal sports LLM and user inputs (e.g., audio, speech, drawings, video, etc.). For example, mapping module 130 may be configured to receive a user input (e.g., audio/speech) requesting information relating to a play within a specific match (e.g., goal scored by Manchester United against Liverpool). Mapping module 130 may generate one or more connections and/or associations with the user input, an event stream (e.g., match between Manchester United against Liverpool), and the data (e.g., trajectories) output by prediction system 128. Based on the generated connections, mapping module 130 may be configured to determine event data via the data (e.g., trajectories) output by prediction system 128, the event stream, and the user input. The mapping module 130 may output one or more graphics, text, audio, or a combination thereof based on the determined connections and/or associations.

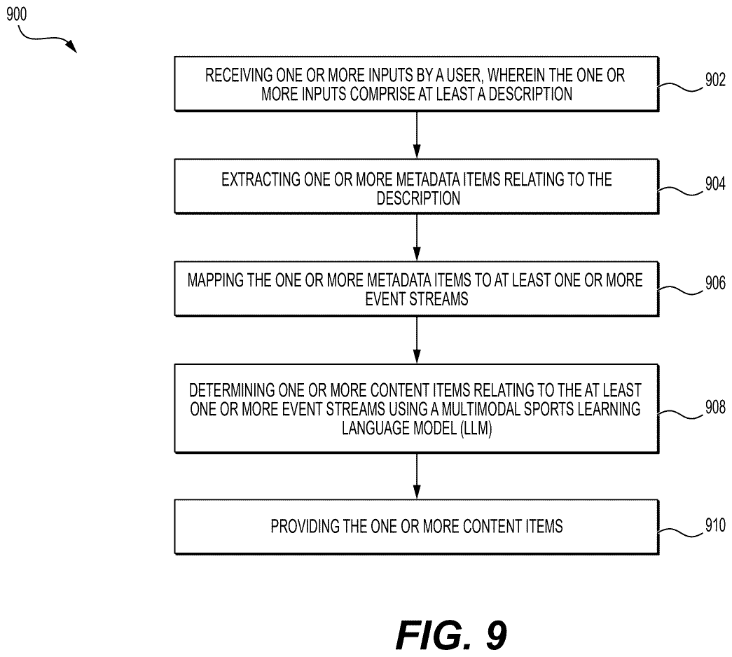

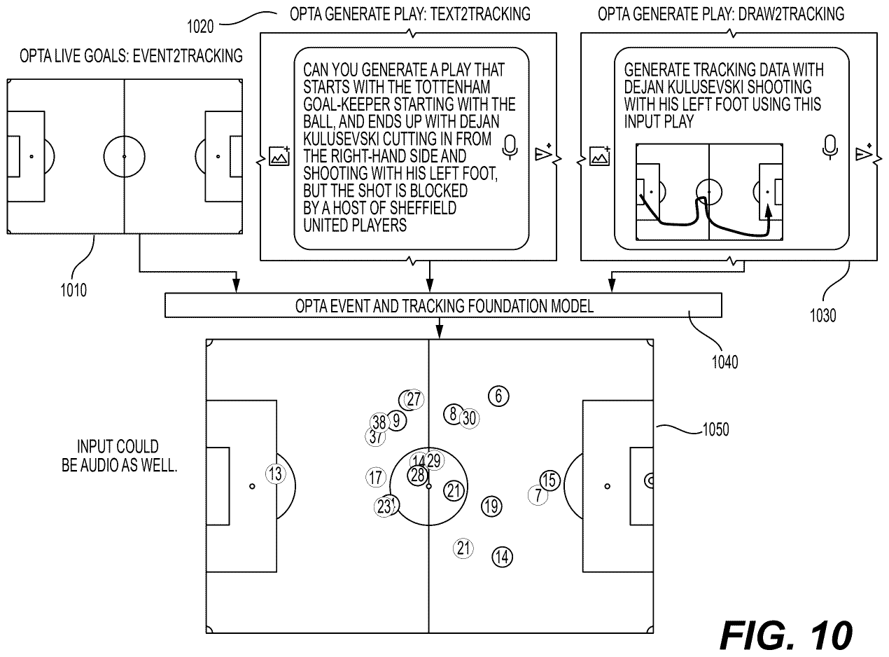

In some embodiments, mapping module 130 may include a separate mapping model tuned for each input type (e.g., audio, text, drawing, video, etc.). Given that each input is very different from each other, there may be times that a single mapping model may have trouble determining connections and/or associations. In such scenarios, one or more individual mapping models may be employed for a single user input. For example, upon receiving a user input (e.g., speech and drawing), mapping module 130 may utilize one or more mapping models for each input type received. The one or more mapping models may determine one or more connections and/or associations from the received inputs. Based on the determined one or more connections, mapping module 130 may output one or more graphics and texts corresponding to the user inputs. Mapping module 130 is discussed further in conjunction with figures discussed below (e.g., FIGS. 9 and 10).

Trait module 132 may be configured or trained to generate or identify player and/or team traits using event data, broadcast tracking data, and/or data (e.g., trajectories) output by the prediction system 128. Player and/or team traits (e.g., pass prediction, decision making, continuous xG) may be used by one or more machine-learning models to predict outcomes for a player and/or a team. For example, event data may include information relating to the option or availability to pass or shoot the ball at one or more points in time during a match. This information may be used to generate a pass prediction trait for a player and a team. The pass prediction trait may be further used by one or more machine-learning models (e.g., prediction system 128) to predict a pass versus shot in a future scenario based on the trajectories output by the prediction system 128. This information may be used to generate graphic and/or text information for broadcasters or individual users.

Another example of generating trait information may include performance under pressure. As similarly described above, event data, broadcast tracking data, and/or data (e.g., trajectories) relating to performance under pressure may be collected and/or aggregated. Once the trait (e.g., performance under pressure) has been generated, individual users may utilize this trait. For example, a coach may use this information in preparation for an upcoming match. The trait information may relate to one or more players on either team. Coaches may utilize this information to determine different match-ups or markings for an upcoming match as well as which players to use to optimize their chances throughout the match. In addition, individual end users (e.g., fans, fantasy players, etc.) may utilize this information to determine how to set their line-up for an upcoming match in their fantasy league.

Fitness module 134 may be configured or trained to generate or identify one or more fitness metrics of a player based on data output by prediction system 128. Fitness metrics can relate to movements, defensive intensity of the player, offensive intensity of the player, trajectories output by the prediction system 128, etc. Example fitness metrics can include player sprints, jogs, on-court time with no movement, average distance to an offensive player during a pick-and-roll or screen, etc. The fitness metrics can each include scores (e.g., 0-100 scores) that can be aggregated to determine an overall fitness metric of the player. In some instances, fitness metrics can be based on different time ranges that the player is on the court. In this example, if the player spends most of their time on the court with no movement (based in part by the trajectories output by the prediction system 128), the fitness metrics of that player can be negatively impacted as the game progresses.

Graphics module 136 may be configured to generate one or more graphics and texts relating to event data, broadcast tracking data, and/or data (e.g., trajectories) output by the prediction system 128 relating to one or more players or teams. For example, the graphics module 136 may receive event data related to a goal being scored by a player, and generate a graphic illustrating the player making the goal as well as text relating to the goal, such as the time when the goal was scored and the total score of the game.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 103. Application 103 may be representative of a web browser that allows access to a website or a stand-alone application. Client device 108 may access application 103 to access one or more functionalities of computing system 104. Client device 108 may communicate over network 105 to request a webpage, for example, from web client application server 114 of computing system 104. For example, client device 108 may be configured to execute application 103 to access content managed by web client application server 114. The content that is displayed to client device 108 may be transmitted from web client application server 114 to client device 108, and subsequently processed by application 103 for display through a graphical user interface (GUI) of client device 108.

Client device may include a display. Examples of the display include, but are not limited to, computer displays, Light Emitting Diode (LED) displays, and so forth. Output or visualizations generated by application 103 (e.g., a GUI) can be displayed on or using the display.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

The system described herein may implement an imputation method that processes broadcast tracking data, fuses broadcast tracking with event data, and utilizes generative AI models to synthesize highly photorealistic trajectories. The output generated based on these techniques may include complete (e.g., imputed) tracking data that is in a form and format that can be used for downstream applications as discussed herein.

The first step of imputation may be to encode broadcast tracking data, which may form the strongest signal for inferring the locations of occluded agents. Two challenges of encoding tracking data may be: (1) modelling each agent's past behaviors, and (2) representing inter-agent spatial dynamics. In the system described herein, the first challenge may be especially difficult, because players often remain occluded for long periods of time (e.g., up to a minute). In response to this challenge, the system may be configured to encode multiple minutes of broadcast tracking at a time.

In conventional systems, tracking data may have been visualized as a two dimensional top-down image and processed through computer vision models. However, while the agents' spatial inter-relationships can be perceived from a single image, the agents' long-term temporal histories cannot. Furthermore, the high dimensionality of images may make it intractable to jointly process more than a few consecutive image frames at a time. In the system described herein, where multiple minutes of tracking context is required, image-based approaches may not be utilized based on the problems described above.

Tracking data may be an inherently compressed data representation, and therefore it may be more efficient to impute behaviors by using a direct stream of data. One important challenge of using tracking data directly is the permutation problem. AI models generally assume that their inputs are consistently ordered (e.g., words passed to a large language model (LLM) are always entered sequentially). However, there may be no natural ordering of players that persists from frame to frame and from game to game, which means that conventional standard deep learning models may be forced to learn the same relationships for each of the, for example, (10!)2 possible permutations of agent orderings (the number of ways in which the two teams of 10 outfield players can be ordered). One approach that conventional systems have implemented to address the permutation problem is to consistently order players by inferring their instantaneous spatial role within a formation template. This method may be limited by its use of a single static template, failing to represent how player roles change depending on the current phase of play (e.g., corners, dead-balls, counterattacks).

Another approach that conventional systems have implemented to address the permutation problem may be by using permutation invariant models (models where changing the order of the players has no impact on the model's output). One such family of models that have this property may be Graph Neural Networks, which may encode information that has an underlying graph structure. These models may have been applied to sports tracking in conventional systems by representing each agent as a node in a fully connected graph, (where there is an edge between every pair of nodes). While formulating tracking data as a graph may solve the spatial modelling challenge, existing applications may have only endowed GNNs with short-term temporal context (e.g., <10 seconds).

The backbone of many modern state-of-the-art AI models may be Transformers, which are neural networks that are closely related to GNNs. Transformers may primarily rely on a single simple operation: self-attention. For a given collection of tokens (e.g., a sequence of words) the attention mechanism will infer each token's (e.g., word's) dependence on every other token from large amounts of training data, and each token is updated with the context with respect to all other tokens. From the success of the attention mechanism on language modelling problems, transformers can learn complex long-term interdependencies within sequential data. This may make transformers an appealing model for encoding tracking data, which contains long-term spatial and temporal dependencies.

The system described herein may utilize a transformer based neural network (e.g., prediction system 128) to fuse multi-agent trajectory with sport's semantic even stream data. The prediction system 128 may implement a score-based diffusion framework as described below.

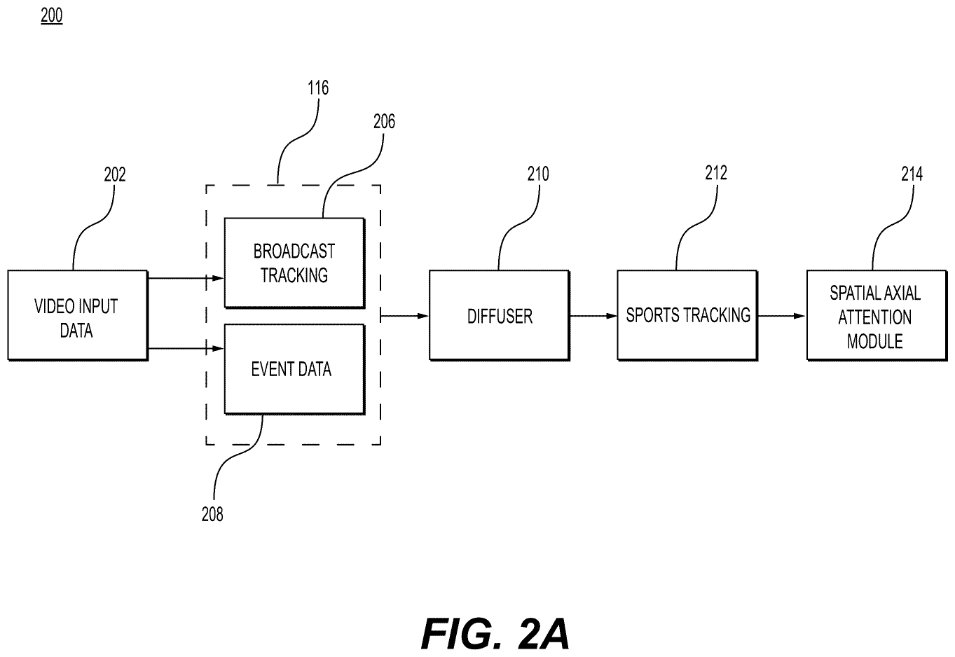

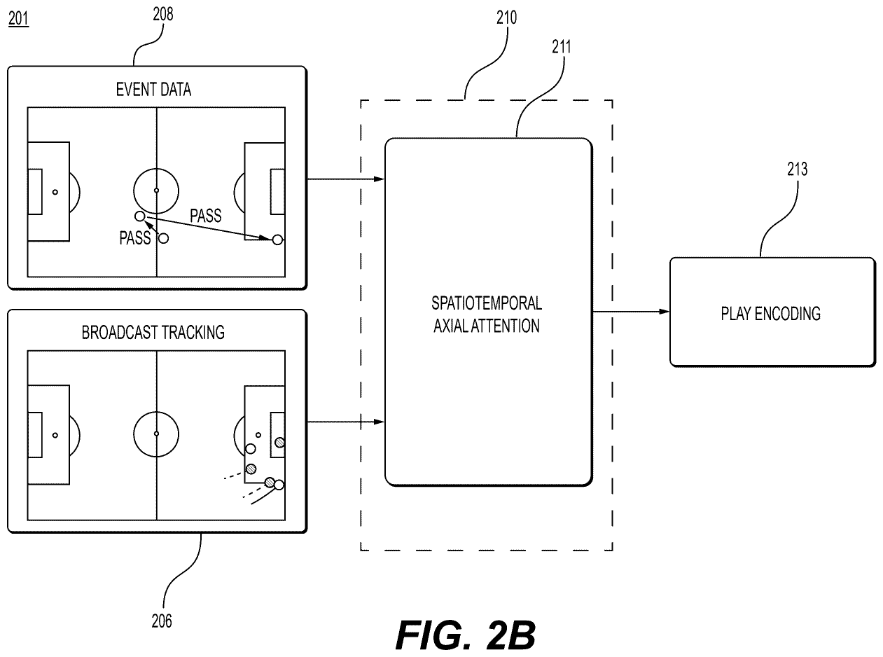

FIG. 2A depicts an exemplary block diagram of a system 200 for a transformer network (e.g., diffuser 210) for generating trajectories of players (e.g., sports tracking information 212), according to one or more embodiments. The system may for example provide conditional guided diffusion (e.g., by diffuser 210) to generate one or more trajectories for a player (e.g., sports tracking information 212) from a limited vision (e.g., from the video input data 202 that includes occlusions).

The system 200 may for example include video input data 202 (e.g., broadcast feed, etc.) of a sports broadcast. As previously discussed, the video input data 202 may be generated by tracking system 102. The video input data 202 may for example have a limited receptive field. For example, occlusions may occur where a subset of players cannot be visually displayed on the video input data 202. These occlusions may occur from diverse sources, caused by a broadcast camera's limited monocular receptive field, close-ups, replays, and alter-native camera angles. The video input data (e.g., broadcast feed) may for example be a subset of geospatial data. Geospatial data may be any content, information, or feed that may allow tracking of one or more objects, as further discussed herein. For example, geospatial data may refer to broadcast footage, in-venue footage, global satellite positioning (GPS) data, radio-frequency identification data (RDIF), Near Field Communication (NFC), triangulation data, and/or the like. Geospatial data and subsequently processed geospatial data (e.g., by tracking data system 116) may for example be received as input by the diffuser 210 described herein. Video input data may refer to broadcast footage or an in-venue computer vision system output which may be or include, for example, raw video content (as discussed above). An in-venue computer vision system may, for example, record video footage of an entire field of play throughout and entire match.

The video input data 202 may, for example, be input into the tracking data system 116. The tracking data system 116 may, for example, perform one or more functions. As previously discussed, the tracking data system 116 may determine broadcast tracking data 206. Broadcast tracking data 206 may be determined by one or more computer vision algorithms. The broadcast tracking data 206 may, for example, be output as multi-agent trajectories for each of the players in a match. The one or more computer vision algorithms may be configured to (1) detect players in a sporting event; (2) classify the detected players into one or more teams; (3) identify a “logical identity” to the identified players in order to maintain identity and track players over a temporal sequence; (4) identify a ground plane of the sporting event; and/or (5) identify the assigned number of each player on the field. The one or more computer vision algorithms may further provide a tracking of identified players over time. The broadcast tracking data 206 may for example be stored in a JavaScript Object Notation (JSON) file. The broadcast tracking data 206 may, for example, as previously discussed, include the two-dimensional tracking of one or players in a match, the players respective team, and the player's respective identifying number (e.g., a player's respective jersey number).

The broadcast tracking data 206 may be based on publicly available broadcast data and/or footage related to a sports event generated or broadcasted at least in part using one or more cameras or camera systems of tracking system 102 of FIG. 1. Broadcast tracking data 206 may include a tracking stream determined using computer algorithms applied to a broadcast feed. The tracking stream may represent the movement of an agent (e.g., a player, other individual, object, etc.). The broadcast tracking stream may be represented as b∈R^{T×E×D}^{_{b}}, where each observation contains the agent's 2D coordinate, agent-type (i.e., outfield player, ball, goalkeeper, etc., team affiliation, and indicators as to whether the ball is in-play, and whether the agent is visible.

The second function of the tracking data system 116 may be to determine event data 208. As previously discussed, the event data 208 may refer to the sequential stream of all major events throughout the match (e.g., pass, shot, tackle, foul, turnover, penalty, goal, score, substitution, etc.). Event data 208 may provide an essential signal for reconstructing the sections of games that are not covered by raw broadcast tracking data. Event data 208 may be detected or generated by any of the methods previously discussed herein. Event data 208 may, for example, be automatically detected by a computing system or input from a user reviewing the video input data 202. For example, event data 208 may be input by a user viewing video input data 202 (e.g., a broadcast feed). The event data 208 may be unified to be a two-dimensional spatiotemporal grid. This may be performed by stacking (with padding) each player's events, forming an event stream s∈R^{L×E×D}^{ₛ} where L is the maximum number of events performed by a single agent over a specified time horizon, and each event includes the event's time stamp, 2D coordinates, agent-type, and event category (e.g., pass). Event data 208 may be referred to as “labeled event data” herein.

The determined broadcasting tracking data 206 and the event data 208 may, for example, be input to diffuser 210. Diffuser 210 may incorporate a transformer based-neural network. Diffuser 210 may include an encoder (e.g., for operations related at least in part to event data 208) and one or more tracking decoders (e.g., for fusion of the event encoder output and the broadcast tracking data 206), as further discussed herein. The diffuser 210 may generate and output trajectories as sports tracking information 212. These may be output as vectors for further analysis and/or presentation. The diffuser 210 may be part of tracking data system 116.

As discussed above, processed geospatial data may be received as input by the diffuser 210 (e.g., in place of or in addition to video data 202). For example, the geospatial data may be based on wearable technology worn by the one or more agents on the field. For example, GPS, RFID, and/or NFC data may be received by the system 200. GPS, RFID, and/or NFC data may correspond to location data tracked using GPS sensors, satellite tracking, proximity sensors, tags, and/or the like. Such location data may provide useful context to the system 200 when sensor information (e.g., broadcast data, in-venue sensor information, etc.) is noisy or missing. Alternatively or in addition, the geospatial data may be based on an in-venue computer vision system. The in-venue computer vision data may be utilized to denoise the input (or merge together in the event data 208). The event data 208 may be received in and/or transformed into the frame of reference which is being tracked. For example, the event data may have a frame of reference from (0, 0, 100, 100) whereby the filed coordinate may be (0, 0, 106, 68). Accordingly, the event data may be transformed into the (0, 0, 100, 100) frame of reference using any applicable scaling technique such as a transformation, transfer, normalization, and/or the like.

Further, the diffuser 210 may be configured to receive labelled input such as human labelled inputs (e.g., only event data 208). The system 200 may be configured to impute the position of one or more objects based on event data 208 (e.g., based only on event data 208). Such a labelled input may be received, for example, in text form and may be converted to tracking data based on analysis of the text and/or based on providing the text to a machine learning model trained to output tracking data based on labeled text inputs. In another example, the system may be configured to impute the event data 208 based on one or more inputs discussed herein. For example, the frame on what time interval an event occurred).

The diffuser 210 may further be configured to output data to a spatiotemporal axial attention module 214. The spatiotemporal axial attention module 214 may be a separate component than the diffuser 210. Diffusion techniques may be applied on top of the spatiotemporal axial attention module 214 to achieve a diverse set of predictions and not just a coarse deterministic prediction. Additional methods that may applied on top of the spatiotemporal axial attention module 214 include another set of temporal filters such as Kalman filters, a long short-term memory (LSTM), and/or additional temporal filters. However, diffusion may provide the most accurate results. The spatiotemporal axial attention module 214 may extract spatiotemporal dependencies from the tracking data. In an example, the spatiotemporal axial attention module 214 may be configured to, for a given pass, determine what the probability is that each attacking player will be the pass receiver. This may be referred to as the xReceiver metric as will be described in more detail below. The spatiotemporal axial attention module 214 may further be configured to perform “ghosting” which may refer to a prediction of an optimal location where a player should have been to minimize the likelihood of a pass, or shot, or goal (xG). In another example, the spatiotemporal axial attention module 214 may be configured to predict which playing style (e.g., a counter attack) the team is using or the type of run a player is executing (e.g., an active run).

FIG. 2B depicts an exemplary block diagram of a system 201 for a spatiotemporal axial attention for generating trajectories of players, according to one or more embodiments. System 201 of FIG. 2B may further include event data 208 and broadcast tracking data 206. The event data 208 and broadcast tracking data 206 may be input into diffuser 210. Diffuser 210 may include a spatiotemporal axial attention mechanism 211 as described in more detail below that is configured to output sports tracking information 213. The output sports tracking information 213 (e.g., play encoding) may refer to the captured information necessary to fully reconstruct a play (e.g., all players and the ball). The output maybe utilized to define the play of the game, and it may further be used to detect specific aspect of a game such as passing options (e.g., for downstream analysis).

Denoising diffusion models may be implemented by the system 201 described herein (e.g., by diffuser 210). Such diffusion models may consider the family of distributions p(x, σ) where Gaussian noise of standard deviation σ is added to a data distribution P_{data} (x) with standard deviation σ_{data}. Where the Gaussian noise standard deviation may be maximized (i.e., σₘₐₓ), this perturbed data distribution may be virtually indistinguishable from pure Gaussian noise. Samples from this data distribution may thus be generated by iteratively denoising x₀˜N(0,σ²ₘₐₓI) over range σₘₐₓ, . . . , σ_{N-2}, σ_{N-1} such that xi˜p(xi, σi). Score-based diffusion models may frame this reverse diffusion process as an ordinary differential equation (ODE) where the derivative of the noised sample x is given by:

$$d x = - \dot{σ} ( t ) σ ( t ) ▽ x log p ( x , σ ) , \qquad ( 1 )$$

Where ∇ₓ log p(x, σ) gives the score function, σ(t) is the noise level at diffusion step t, and \dot{σ}(t) is the time derivative of σ. The score function may be a vector field that gives the direction where the probability density function grows most quickly, from which the underlying probability density function can be inferred. The probability distribution's score function can be obtained by training a conditional de-noising model D_{θ}(x, σ, c) parameterized by θ to minimize the L2 reconstruction loss between the perturbed and original data sample,

$${E}_{σ ∼ q ( σ )} {E}_{x , c ∼ {p}_{d a t a}} {E}_{n ∼ N ( 0 , {σ}^{2} I )} // {D}_{θ} ( y ; σ , c ) - x // {2}_{} , \qquad ( 2 )$$

Where q denotes the distribution of o during training and y=x+n. Following this definition, the score is given by:

$${∇}_{y} log p ( y , σ , c ) = ( {D}_{θ} ( y ; σ , c ) - x ) / {σ}^{2} \qquad ( 3 )$$

Training and preconditioning may be implemented for a diffuser model used herein. Such models (e.g., deep models) may learn most effectively when their inputs and outputs are scaled to have unit variance. Furthermore, at low values of σ it may be easier to predict the noise level n, whereas at high values of σ it is easier to predict the clean original signal x. Consequently, rather than directly returning the raw output of the denoiser neural network, the diffuser described herein (e.g., diffuser 210) may add preconditioning terms to both scale the variance of the model's inputs, and a skip connection to enable the model to adaptively predict either the noise level or the clean signal for different levels of σ. The denoiser can be written as:

$${D}_{θ} ( y , σ , c ) = {c}_{skip} ( σ ) y + {c}_{out} ( σ ) {F}_{θ} ( {c}_{input} ( σ ) y ; {c}_{noise} ( σ ) , c ) \qquad ( 4 )$$

Such that F_{θ} is the raw neural network's output, cᵢₙₚᵤₜ modulates the perturbed trajectory's variance, cₙₒᵢₛₑ modulates the noise's variance, Cout modulates the output's variance, and cₛₖᵢₚ modulates the skip connection. To normalize losses over the σ range, the per-sample reconstruction losses are scaled by term λ(σ)=1/c². c may represent a raw input to the neural network, and may be assumed to be modulated.

Constrained sampling may be applied by the diffuser described herein. The diffusion model described herein (e.g., diffuser 210) may learn the conditional score function ∇y log p(y, σ, c) of the probability distribution of multi-agent trajectory sets. However, it is often preferable to sample from the joint score function:

$${∇}_{y} log p ( y , σ , c ) + {▽}_{y} log q ( y , σ , c ) , \qquad ( 5 )$$

Where the second term represents the constraint gradient score for manifold q over y. This constraint manifold may represent any loss function: L:R^{T×E×2}→R that can be differentiated with respect to y. Scaled by hyper parameter α, the constraint gradient score can be calculated as:

$$∇ log q ( y , σ , c ) ) = α \frac{\partial }{\partial y} L ( {D}_{θ} ( y ; σ , c ) ) . \qquad ( 6 )$$

With the ODF dynamics described in equation (1) above, sampling from the diffuser 210 may be performed using, for example, approximately 128 inference steps of the Henu sampler.

In order to prepare (e.g., train) and/or validate diffuser 210, the diffuser 210 is provided access to multiple streams of spatiotemporal data such as video input data 202 (e.g., including broadcast tracking data 206 and/or event data 208) and may be provided in-venue tracking data. Such streams may be represented as spatiotemporal grids which consist of a temporal dimension T specifying the length of trajectories, a spatial dimension (e.g., of size E=23) denoting the number of agents (e.g., two teams of 11 and one ball), followed by a feature dimension. The perturbed in-venue trajectories may be written as y∈R^{T×E×2}, where each observation specifies the agent's perturbed 2D location. Similarly, the broadcast tracking stream is represented as b∈R^{T×E×D}^{_{b}}, where each observation contains the agent's 2D coordinate, agent-type (i.e., outfield player, ball, goalkeeper), team affiliation, and/or indicators as to whether the ball is in-play, and whether the agent is visible. Observations that are not visible may have the agent's 2D coordinate zeroed. While event data may be typically represented as a 1D temporal stream, the event data 208's data stream is represented to be a 2D spatiotemporal grid. This may be achieved by stacking (with padding) each agent's events, forming event stream s∈R^{L×E×D}^{ₛ} where L is the maximum number of events performed by a single agent over a specified time horizon, and each event includes the event's timestamp, 2D coordinates, agent-type, and event category (e.g., pass).

The diffuser 210 may apply spatiotemporal axial attention. The diffuser 210 may process the modalities in a way that maintains their underlying spatiotemporal structure. While spatiotemporal data has a clear temporal total ordering (i.e., chronologically), no such natural ordering may exist over agents spatially. In soccer, because there are two teams each with 10 outfield players with no natural ordering, there may be (10!)² possible permutations of agent indices. To avoid a combinatorial increase in complexity, the spatial dimension of spatiotemporal grids may be processed in a permutation equivariant manner. That is, for example, the following equality may hold for every permutation p of agent indices:

$${F}_{θ} ( y ; {σ}_{,} c ) = {F}_{θ} ( {y}^{p} ; {σ}_{,} {c}^{p} ) , ∀ p ∈ [ 1 , {( 10 ! )}^{2} ] , \qquad ( 7 )$$

Where y^{p} and c^{p} may represent permutations of the agent indices for the perturbed in-venue tracking and contextual vectors respectively.

This property may be obtained using spatiotemporal axial attention, where self-attention is applied across temporal and spatial axes separately. With this scheme, individual agent motion may be learned through temporal attention, while collective group dynamics can be learned through spatial attention, without imposing an artificial ordering upon agents. Another benefit of axial attention may be its computation efficiency. Standard self-attention may have quadratic performance with respect to sequence length, and therefore jointly attending across spatial and temporal axes has O(T²·E²). Separate axial attention is of O(T²)+O(E²)=O(T²) complexity in cases where sequence length T dominates the number of agents E. This efficiency improvement in the diffuser 210 may allow for the processing of considerably larger length multi-agent trajectories than conventional systems.

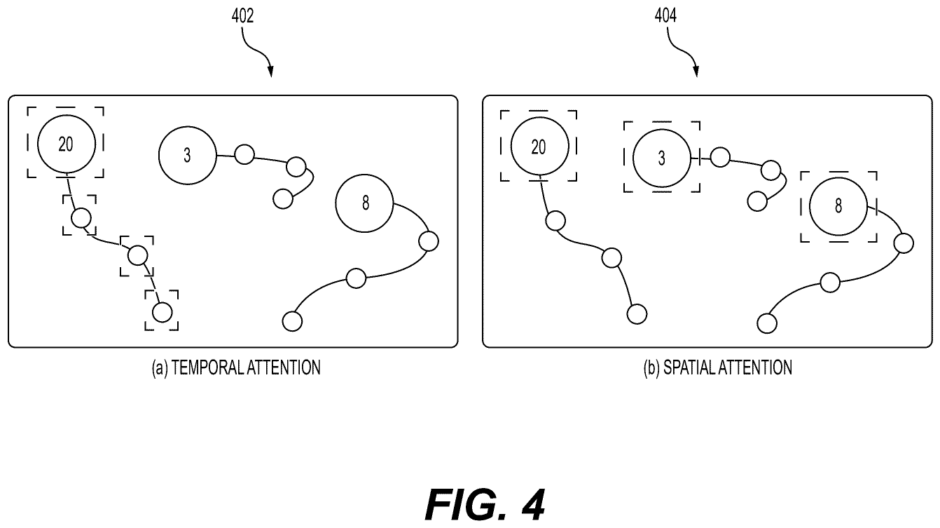

The system described herein may apply techniques to adapt transformers to sports tracking data through spatiotemporal axial attention which includes two interleaved attention modules: temporal attention 402 and axial attention 404 as depicted in FIG. 4. In temporal attention 402, each agent's (e.g., player, referee, object, ball, etc.) temporal context is encoded by completing self-attention between each of an agent's past locations. Conversely, in spatial attention 404, the spatial relationships within a single frame may be modelled by completing self-attention between each agent's locations at that instant. By interleaving these operations, both the temporal and spatial dependencies within the sporting scene may jointly be modelled. Spatiotemporal axial attention (“SAA”) may have two key advantages: First, SAA may avoid the permutation problem described above as no ordering is imposed on agents. Secondly, temporal attention may be an extremely computationally efficient method for modelling agent's long-term histories. This may be important when accurately predicting the behaviors of agents that are occluded for long periods of time.

Although broadcast tracking provides an essential signal for the accurate synthesis of complete tracking data, it has several limitations. First, broadcast tracking may struggle to track the ball continuously and accurately, due to its small size and fast movement. Secondly, there may be many continuous periods of the game where broadcast tracking does not provide any coverage. Although these periods are typically relatively short (e.g., <10 seconds), synthesizing accurate agent behaviors for these segments may be extremely difficult without additional contextual information. The system described herein may address these challenges by integrating event data with broadcast tracking data to estimate occluded agent behaviors. This may be a shift away from conventional systems that treat sport as a unimodal domain (only using tracking data). The system described herein may treat sports as multi-modal, including multiple spatiotemporal input such as tracking data and event data.

The system described herein further considers that, like tracking data, event data may also be framed as a spatiotemporal modality, including a temporal dimension (i.e., the chronological ordering of each player's events), and a spatial dimension (i.e., representing each specific player) and thus can be encoded using SAA. The system may utilize the flexibility of the transformer architecture (e.g., by diffuser 210) by jointly processing these modalities together to produce an encoding that contains both tracking and event context, as depicted in FIG. 2A and FIG. 2B. Collectively, this architecture may enable the first fusion of event and tracking data in a deep learning model, which is a landmark moment for the ways in which sports data is understood and processed by AI models.

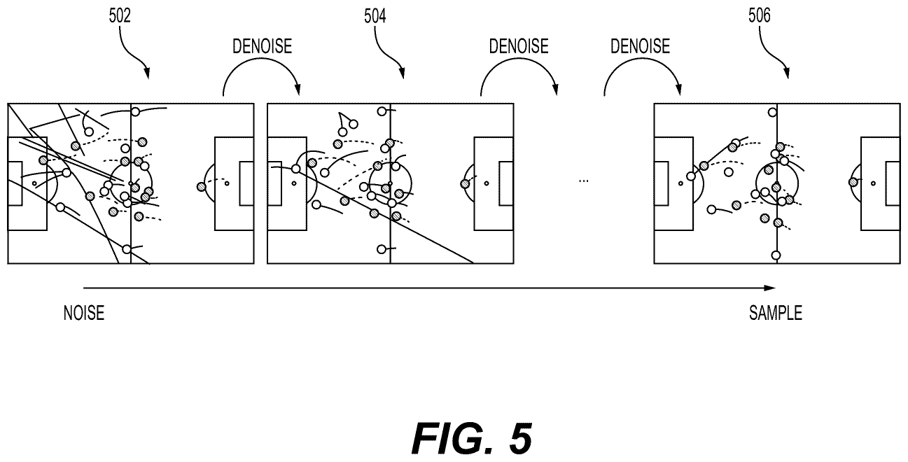

The system described herein may apply techniques for fusing event data with broadcast tracking data can accurately predict agent locations, however these locations collectively do not necessarily form realistic human motion. This is caused by the high level of uncertainty in agent locations, particularly in the presence of noise and heavy occlusions in the broadcast tracking input. In practice, this means that behaviors generated in this way often model exhibit jitter (i.e., unsmooth trajectories) and occasionally teleport between locations. To alleviate these issues in generating agent behaviors, the system may utilize diffusion, (e.g., a family state-of-the-art generative AI models that have most notoriously been used in the generation of highly realistic images from captions). At a basic level, diffusion models may synthesize data via iteratively denoising from a random initial state. Starting with pure noise, diffusion models progressively refine the sample, gradually creating a higher and higher fidelity generation. The process of iterative denoising may make the diffusion approach well-suited to the generation of images. Iterative denoising may lead to the models learning to construct the coarse features (e.g., the subject of an image) and granular features (e.g., visual texture) that include an image, resulting in highly photorealistic generations. Diffusion may have similar advantages in the generation of tracking data that also contains both rich coarse features (e.g., agents' rough locations) and granular features (e.g., the smoothness of agent motion). Moreover, just as images can be generated by diffusion models by conditioning on textual captions, the system described herein may generate complete tracking data that are conditioned on broadcast tracking and event data streams. FIG. 5 depicts tracking data being generated by diffusion, according to one or more embodiments. Graph 502 depicts data prior to denoising. Graph 504 depicts the data after a first round of denoising. Graph 506 depicts a sample of the data once denoising is complete. FIG. 5 may visualize how tracking data is generated with diffusion via iteratively denoising an initial pure noise sample. Gradually, this noise may be refined to form a highly realistic tracking data.

To evaluate the accuracy of imputation, downstream metrics from in-venue tracking and our imputed tracking may be extracted from an exemplary game. The outputs of the system may be compared to in-venue tracking to determine the accuracy of the system. In one example, for a given pass, it was analyzed what the probability that each attacking player will be the pass receiver is (e.g., the xReceiver metric). The xReceiver metric may be dependent both on agents' coarse locations and on more fine-grained details such as agent velocities, accelerations, and body orientations. For the xReceiver outputs to match the outputs of in-venue tracking, the imputed data may be required to correctly synthesize the complex features in trajectory space. Described below is the method for implementing the xReceiver model (e.g., the spatiotemporal axial attention module 214), along with comparisons of the xReceiver model outputs for in-venue tracking, raw broadcast tracking, and our imputed tracking.

The xReceiver model may have been trained and validated on a set of sporting event games. For example, the model may have been trained on a set of one hundred games from a particular league (e.g., English Premier League season) and from a particular season of a sport (e.g., from 2023 to 224). The training and validation data may include both the both the in-venue tracking and broadcast tracking data. The training may focus on predicting successful passes with a focus on the five second of tracking context leading up to the 0.2 seconds before a pass is performed. By utilizing tracking data directly, rather than extracting handcrafted features (e.g., velocity and acceleration), the models may have an increase in the amount of information available and be less sensitive to small amounts of noise. In an example, the model may use a 90:10 training and validation split, with features including each agent's (x, y) locations, the agent's type (i.e., goalkeeper, ball, or outfield player), and an indicator as to whether the agent is on the attacking team. It will be understood that the above is an example only and the model described above and/or below may be implemented using values that are different than those provided above (e.g., such values may be up to 500% more or less than those provided in the example, up to 1000% more or less than those provided in the example, and/or the like).

The xReceiver model may utilize SAA as the underlying architecture, as this may extract spatiotemporal dependencies from tracking data. All agents' trajectories may be processed by a SAA module followed by a linear projection. Next, each attacking agent's outputs may be fed through an activation function (e.g., a softmax activation function), which may ensure that the xReceiver model maintains the Law of Total Probability (all player xReceiver values sum to 1). The models may be trained using cross entropy loss. Two instances of this model may be trained, one using in-venue tracking to comprise agent locations, and another that uses broadcast tracking.

The results of the xReceiver model may have been tested, for example, on a single game using three datasets: in-venue tracking, raw broadcast tracking, and the determined imputed tracking. During testing, the xReceiver model trained on in-venue tracking may be applied to in-venue tracking. Likewise, the xReceiver model trained on raw broadcast tracking may be applied to the raw broadcast tracking data. In the case of imputed tracking, the model trained on in-venue tracking may have been used. This may enable an analysis of imputed tracking data's ability to be substituted for in-venue tracking.

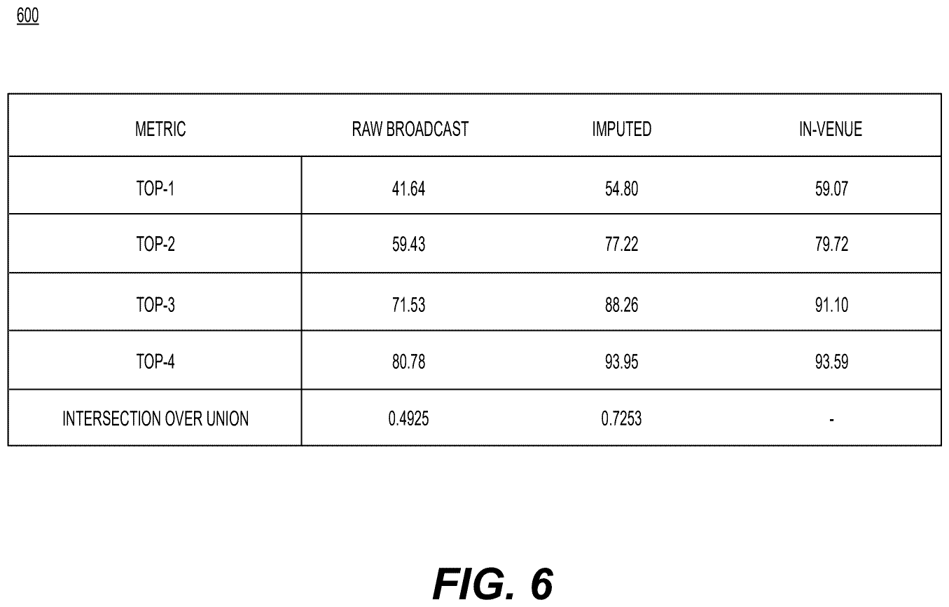

Two metrics may be used to compare the quality of the raw broadcast and imputed tracking's xReceiver outputs with the in-venue outputs. The first metric may be how frequently the true receiver is among the top-k most likely predicted receivers from each dataset. The second metric may be the similarity between the high likelihood receivers (e.g., receivers with an xReceiver value over 0.1) in the in-venue data, and in the raw broadcast and imputed data. To quantify this similarity, the system may compute the Intersection over Union (IoU) separately between the in-venue and raw broadcast outputs, and in-venue and imputed outputs. The output of this data may be depicted in the graph 600 of FIG. 6.

Examining the results of the graph 600 as applied to the test game, a notable result may be the poor performance of broadcast tracking, which exhibits the weakest performance in each of the extracted metrics. This shows adverse impacts that occlusions have on data-driven analysis of tracking data. Comparatively, the imputed data (determined by the system described herein) may have a much stronger performance. In terms of the top-k metrics, the imputed data's xReceiver outputs closely approach the accuracy shown with in-venue tracking data. In terms of the IoU metric, the imputed tracking data also considerably outperforms the raw broadcast tracking data.

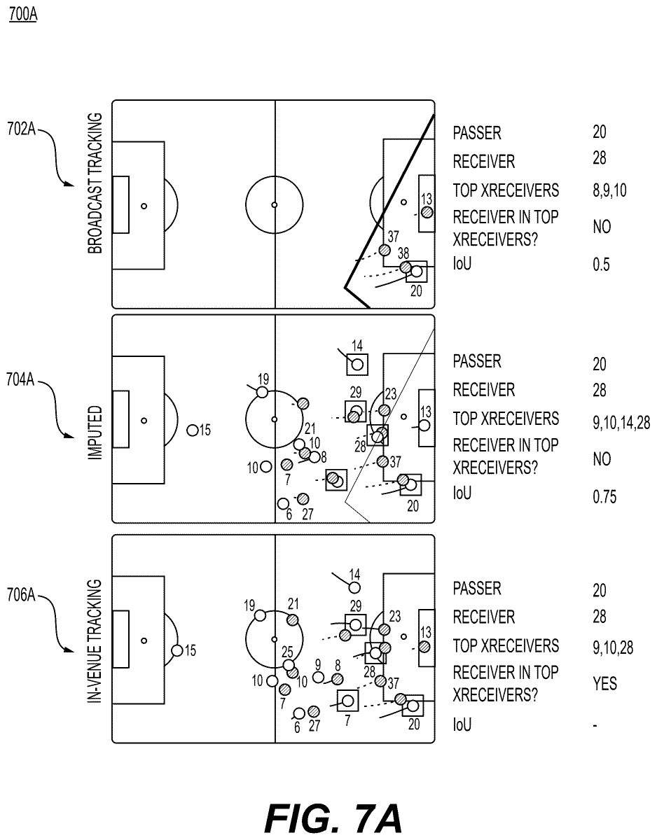

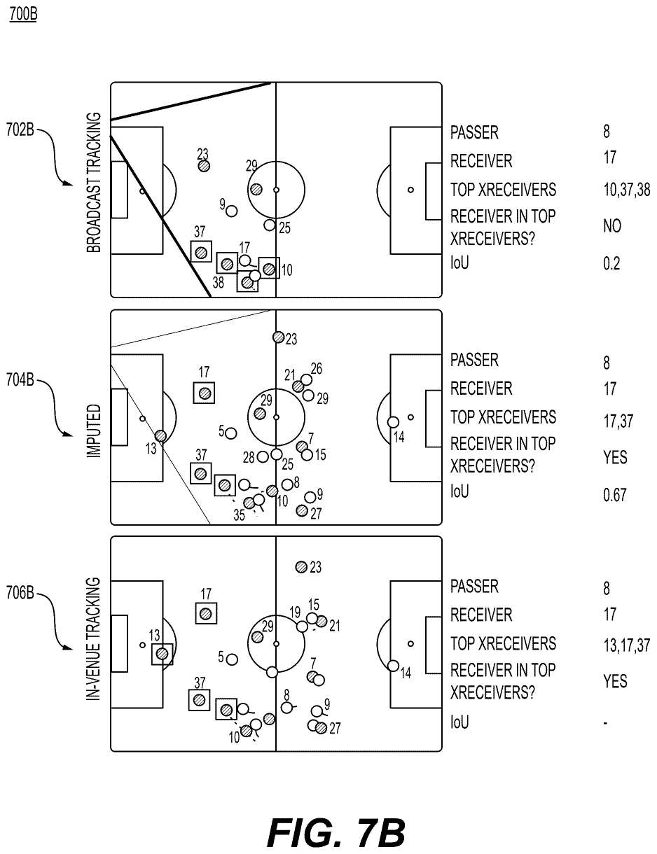

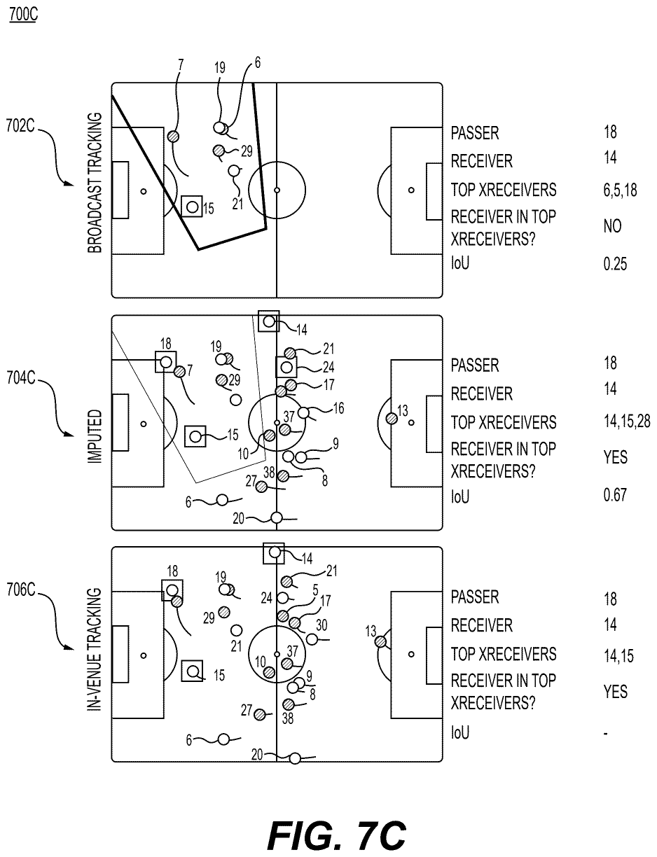

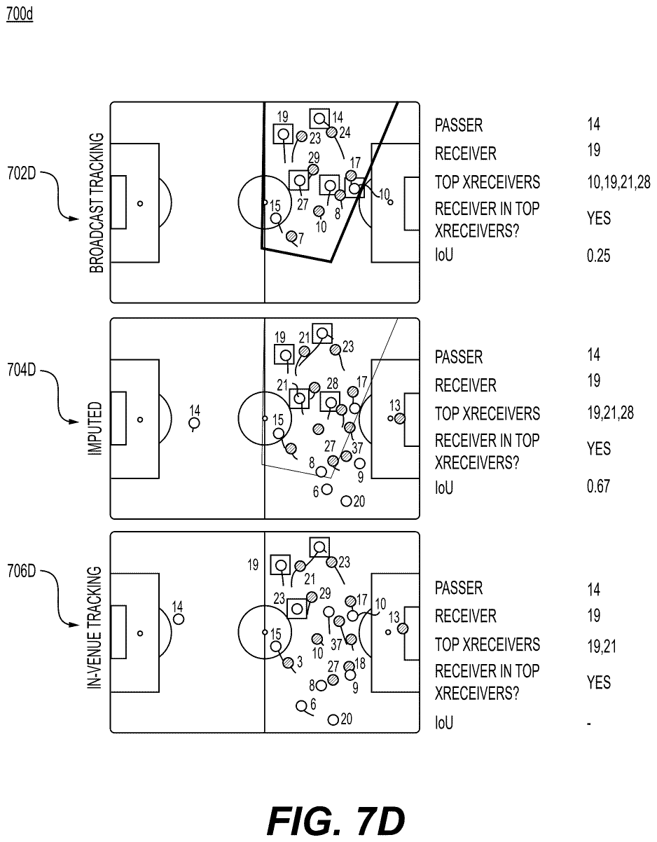

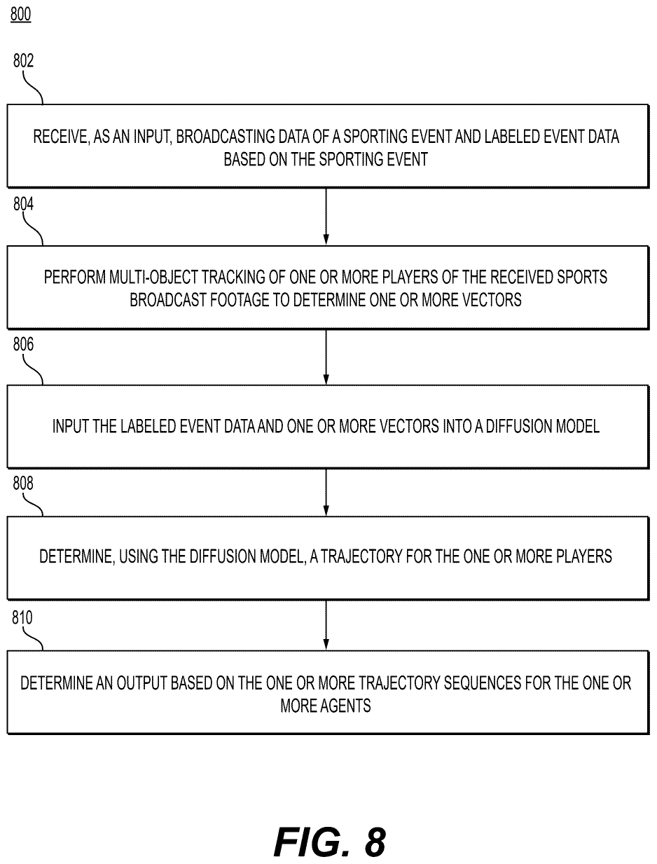

Examining the scenario described in FIG. 3 above, output data 700a of the imputed tracking data (e.g., from the xReceiver), as shown in FIG. 7A, may depict that the play ends with Player #20 crossing the ball to Player #28, who registers a shot-on-target form near the penalty play. Examining this scenario, the system may further be configured to analyze what other players were available for passes and the potential success based on the pass play. For example, the system may consider what pass is the most threatening (e.g., likely to result in a goal) or how likely a pass is to succeed.

In the example scenario of FIG. 3, the broadcast tracking's xReceiver model 702a may determine that there are three likely receivers (e.g., Player #13, Player #37, and Player #38), none of which are the actual receiver. This inaccurate output is representative of the negative impact of incomplete tracking data on downstream analysis. It is also notable that regardless of the predictive outputs of the xReceiver model, without complete tracking data, these predictions may be incredibly difficult to interpret (e.g., why certain occluded players are deemed more likely than others to receive the pass?).

The imputed xReceiver model 704a may predict that there are four likely pass receivers (e.g., the four circles each surrounded by a square), of which the actual receiver is included. Upon review, this output appears viable as the four players clearly making attacking runs towards the box as the passer is set to cross the ball. Visually, the locations of imputed players closely match the in-venue locations. Furthermore, the player trajectories resemble smooth human motion.

The in-venue xReceiver model 706a may predict that there are three likely receivers of the pass (e.g., the four circles each surrounded by a square), one of which is the actual receiver. The discrepancy between the imputed and in-venue result is that the in-venue xReceiver model does not deem Player #28 as a high likelihood receiver. Qualitatively, this may only be a minor discrepancy, as Player #28 appears the least likely of the four candidate players predicted by the in-venue stream to receive the ball.

FIG. 7B-7D may depict further example scenarios applying the xReceiver model to different scenarios. Output data 700b, 700c, and 700d may be depicted in FIG. 7B-7D. FIG. 7B-7D may all depict how the broadcast tracking model (702b, 702c, and 702d) made less accurate predictions as compared to the imputed xReceiver model 704b, 704c, 704d when compared to the in-venue xReceiver model 706b, 706c, 706d results. In these examples, potential receivers and/or possessors of the ball are each surrounded by a square.

FIG. 8 depicts an exemplary flowchart 800 of a method of performing imputation algorithms on predicted tracking data, according to one or more embodiments. The flowchart 800 may for example be performed by system 200 of FIG. 2A or system 201 of FIG. 2B. Flowchart 800 may depict a method for tracking one or more individuals during a sporting event and predicting one or more actions for the one or more individuals.

At step 802, the system may receive, as an input, broadcasting data (e.g., broadcast tracking data) of a sporting event and labeled event data of the sporting event. The labeled event data may include a sequential stream of one or more major events throughout a sport event, the major events including at least one of a pass, shot, tackle, foul, turnover, penalty, goal, score, or substitution from the sporting event. The event data may be represented as a two dimensional spatiotemporal grid, the grid representing a stacking of each player's events.

At step 804, the system may perform multi-object tracking of one or more agents of the received geospatial data to determine one or more vectors. The one or more vectors may include at least one of an agent's two dimensional coordinates on a sporting event's field, an agent's position, an agent's team, an indicator indicating the agent is an object or a player, or player visibility information.

At step 806, the system may input the labeled event data and one or more vectors into a diffusion model. The diffusion model may include a transformer. The transformer may be configured to apply spatiotemporal axial attention through temporal attention and axial attention techniques.

At step 808, the system may determine, using the diffusion model, one or more trajectory sequences for the one or more agents. The diffusion model may apply spatiotemporal axial attention on the received event data and one or more vectors, where self-attention is applied across temporal and spatial axis, separately.

At step 810, the system may determine an output, based on the one or more trajectory sequences for the one or more agents. The output may, for example, be determining the likelihood of a sequence of events occurring in the sporting event. In an example, the output may be the probability that a particular player will receive a pass at a particular future time.

The outputs of step 810 may be data generated by the prediction system 128, mapping module 130, trait module 132, fitness module 134, and/or graphics module 136. For example, with respect to the prediction system 128, the output of step 810 may further include, determining, one or more alternative trajectory sequences for the one or more agents, the one or more alternative trajectory being trajectories of highest predicted success for the one or more agents (also referred to as a “ghosting type output”). This may involve implementing the prediction system 128 described herein, where the training data was based on historical data indicating good, average, and bad locations of players on a field, and outputting simulated movements based on the training data. The highest chance of success may refer to a higher probability of completing a pass or a highest probability of scoring a goal. The system may further determine what a particular team should have performed (e.g., a formation change or substitution).

With respect to mapping module 130, step 810 further comprises steps described in FIG. 9. FIG. 9 depicts an example flowchart 900 for generating one or more graphics, text, audio, or a combination thereof based on the determined connections and/or associations, in accordance with an aspect of the disclosed subject matter. At step 902, one or more inputs by a user or system (e.g., a user query) may be received. The one or more inputs may include a description of a sporting action (e.g., a play), a question, a team or player, etc. and may be in a text format, audio format, visual format, event/tracking data format, or the like. For example, client device 108 may be executing application 103 providing an interactive user interface. A user may make a selection to input a query (e.g., “show me the last goal scored between Manchester United and Liverpool”) using one or more input techniques.

At step 904, one or more metadata items related to the description may be extracted. For example, mapping module 130 may extract metadata items (e.g., contextual items) from the user input (e.g., description) to generate one or more connections and/or associations relating to a game or sporting event. The one or more metadata items may correlate aspects of the description with features that can be mapped to the event stream. The event stream, as previously discussed, may include broadcast tracking data 206, event data 208, and may further include one or more trajectory sequences for the one or more agents as determined by, for example, the method disclosed in FIG. 8. Alternatively, the event stream may just include the broadcast tracking data 206 and event data 208, and the one or more trajectory sequences for the one or more agents may be a separate input. Accordingly, at step 904, a user input query (e.g., description) may be translated into a format that allows mapping the input query to an event stream.

For example, at step 904, mapping module 130 may use a generative model to convert the description received as a query into one or more metadata items associated with one or more sporting events. The metadata items may be specific items provided in the description (e.g., player, team, sporting event, etc.) and/or may be items identified by the generative model to be associated with the specific items provided in the description (e.g., specific plays, opponent information, types of event actions, types of tracking data, etc.). Accordingly, the generative model disclosed herein that is trained based on, for example, historical or simulated sport event information, may be used to generate metadata items that meet a threshold correlation value to the description. In doing so, the generative model may exclude unrelated metadata items, allowing for faster and more efficient subsequent operations limited to the identified metadata items.

At step 906, the metadata items may be mapped to one or more event streams. The mapped event stream and/or contextual information associated with the mapped event stream may be provided to a multimodal sports LLM model. For example, after determining one or more contextual items, mapping module 130 may determine one or more connections and/or associations to the event stream based on the determined contextual items. In doing so, the mapping module 130 may translate the user input query from a first format into a second format recognizable by one or more components and/or machine learning models. The second format may include the connections and/or associations to the event stream. Accordingly, at step 906, one or more event streams corresponding to the query may be identified based on the mapping.

The one or more event streams as well as the connections and/or associations determined at step 906 may be provided to a multimodal sports LLM model, as discussed above. The multimodal sports LLM model may be trained to determine content items from the event streams.

At step 908, the multimodal sports LLM model may apply the connections and/or associations identified based on the query to the one or more event streams. Applying the connections and/or associations to the event streams may include, for example, assigning a correlation score to subsets of the event streams. For example, the multimodal sports LLM model may assign attributes to each subset of the event streams. The attributes may be based on the broadcast tracking data 206, the event data 208, and/or the one or more trajectory sequences for the one or more agents corresponding to each applicable subset of the event streams. The attributes may cluster such data by the actions (e.g., play types, players, teams, actions, events, scores, passes, etc.) performed therein. The attributes may be determined by identifying the actions performed in each respective subset of the event streams. The multimodal sports LLM model may then assign a correlation score to each subset of the event streams and the connections and/or associations identified based on the query. For example, the query may call for goals scored in a given sporting match. At step 906, connections and/or associations associated with a goal being scored may be identified. These connections and/or associations may, for example, include proximity of an offensive player to a goal (e.g., based on tracking data), the movement of a ball in proximity to the goal (e.g., based on tracking data), the accordance of a scoring event (e.g., based on tracking data or excitement data), or the like. The multimodal sports LLM model may assign a high correlation score to the subset of the event streams that indicate a goal scored or attempted based on the attributes associated with each respective subset of the event streams. The correlation score may be determined based on a degree of overlap or correlation between the attributes for a given subset of event stream and the connections and/or associations identified based on the query. For example, a subset of an event stream that is assigned a goal scored attribute may have a higher correlation score in comparison to a subset of an event stream that is assigned a pass made attribute based on respective broadcast tracking data 206, event data 208, and/or one or more trajectory sequences for the one or more agents.

At step 908, the multimodal sports LLM model may identify content items corresponding to the subset of event streams that have a correlation score higher than a threshold correlation score. Continuing the example above, a subset of an event stream that has attributes associated with a goal scored may have a correlation score higher than a threshold correlation score. Accordingly, video and/or audio content associated with that subset of the event stream may be identified by the multimodal sports LLM model as content items for output. The content items may further include a description of the subset of the event stream generated by the multimodal sports LLM model to describe the actions performed in that subset of the event stream. For example, the multimodal sports LLM model may translate the video and/or audio data in the subset of the event stream into a summary or analysis of the actions performed in that subset of the event stream (e.g., based on the audio/video feed, based on broadcast information, based on associated broadcast tracking data 206, based on associated event data 208, based on the one or more trajectory sequences for the one or more agents, etc.).

Accordingly, at step 908, one or more content items that relate to the one or more mapped event streams (or subsets thereof) may be output by the multimodal sports LLM. As discussed herein, the multimodal sports LLM may be trained to output actual or generated event data, tracking data, video content, audio content, summaries, analysis, and/or other content that correlate with the event streams mapped at step 906. As discussed above, mapped event streams may provide features, criteria, and/or boundaries for the information requested via the query, in a format that allows multimodal sports LLM to output a response to the query.

At step 908, the one or more content items output by the multimodal sports LLM may include actual or generated event data, tracking data, video content, audio content, summaries, analysis, and/or other content in response to the user query. The actual or generated event data, tracking data, video content, audio content, summaries, analysis, and/or other content may include player and/or object position information, movement information, trends, changes, plays, event actions, and/or the like in response to the user query.

At step 910, the actual or generated content items output by the multimodal sports LLM may be provided to the user (e.g., via a user device). The output may be provided as a visual display depicting the player and/or object position information, movement information, trends, changes, summaries, analysis, and/or the like in response to the user query. For example, the player and/or object information may be provided in a video format that depicts a play corresponding to the player and/or object information. The video may correspond to the identified subset of one or more event streams that exceed the correlation threshold and may progress from the beginning to an end of the play and may include indicators representing the player and/or object information. As another example, the player and/or object information may be provided in an image format. The image may depict player and/or object information over the course of a given play.

At step 910, the actual or generated content items may be formatted in a manner or order determined by the multimodal sports LLM based on the query. For example, where multiple subsets of event streams meet the correlation threshold, the multimodal sports LLM may identify a priority order for outputting the content streams generated based on the multiple subsets of event streams. The priority order may be determined by applying weights to each of the multiple event streams (and corresponding content streams). The weights may be generated by the multimodal sports LLM based on the description of the query. The multimodal sports LLM may be trained to determine such weights based on training data that includes historical or simulated event streams, subsets of event streams, queries, weights, content streams, and/or the like. Accordingly, the multimodal sports LLM may be trained to prioritize content streams that most correlate to the query and output the content streams in an order based on such prioritization (e.g., using the weights described above).

In addition, a user may input additional inputs (e.g., text, audio, drawing, etc.) to make further refinements of the inputted description. After each additional input, the system may further extract one or more additional metadata items relating to the refinements of the description. Upon determining the one or more additional metadata items, the system may perform steps similar to steps 906 to 910 as described above. This process (e.g., step 902 through step 910) may be repeated as necessary to produce a display as requested by the user.

FIG. 10 depicts a user of a client device inputting a query into the system to provide (e.g., display) a generated outcome. The input as entered may be in the form of the event stream 1010 (e.g., Event2Tracking), text data 1020 (e.g., Text2Tracking), or visual data 1030 (e.g., Draw2Tracking). Event stream 1010 may be a file or may otherwise be provided as broadcast tracking data 206, event data 208, and/or one or more trajectories for one or more agents (e.g., based on a historical event). Text data 1020 may be a textual input which may be input by a user or may be provided as an audio input converted into a text input. Visual data 1030 may be a drawing, illustration, or other visual input generated by a user. It will be understood that multiple inputs (e.g., text data 1020 and visual data 1030) may be included in a single input query. Upon entering one or more inputs, the system may extract one or more metadata items (e.g., keyword(s) and/or tag(s)) based on the received input, using one or more machine learning models (e.g., event and tracking foundation model 1040). Once the metadata has been extracted, an output 1050 may be displayed to a user. The output 1050 may include one or more sports event data associated with the determined one or more keyword(s) and/or tag(s).

For example, the user input may be in the form of a question or “prompt” entered as text. The mapping module 130 may receive the user input and extract metadata (e.g., contextual information) using one or more machine learning models. Extracting metadata may include determining at least one keyword or tag associated with the description or query. Upon extracting the metadata (e.g., keyword(s) and/or tag(s)) associated with the user input, mapping module 130 may further identify an event stream and generate connections therebetween. Mapping module 130 may utilize one or more mapping models depending on the input type used to extract and determine contextual relations.

In any scenario, the user may input a query (e.g. text and/or drawing description) describing the outcome (e.g., tracking data and/or event data) of a series of events to be provided by the multimodal sports LLM. The system (e.g., mapping module 130) may output (e.g., output 1050), using the description, an outcome showing each event (e.g., in series) as entered via the user query, as if the events were to happen in a real match. The output may be simulated or historical event or tracking data and may be converted into a visual display depicting player and/or object tracking information and/or events.

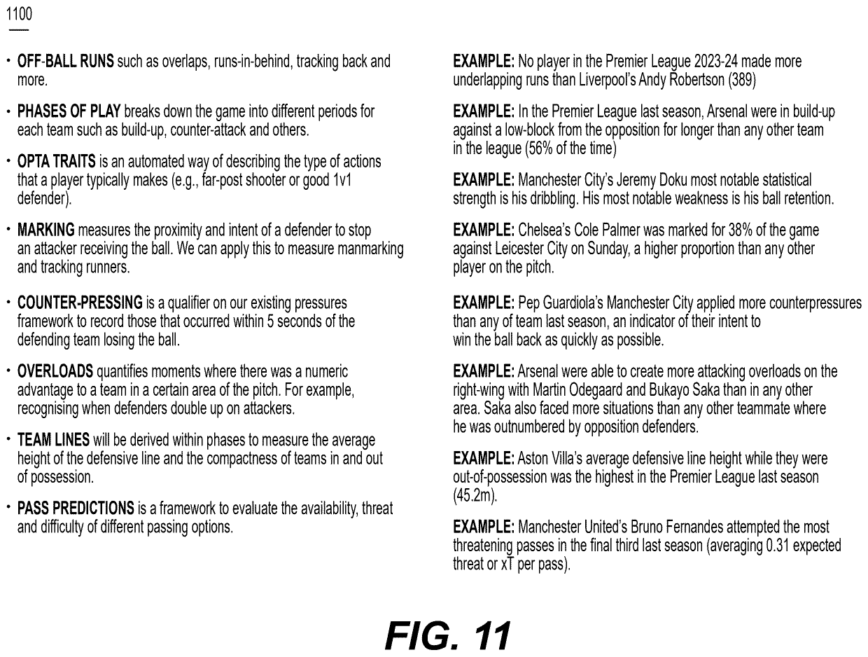

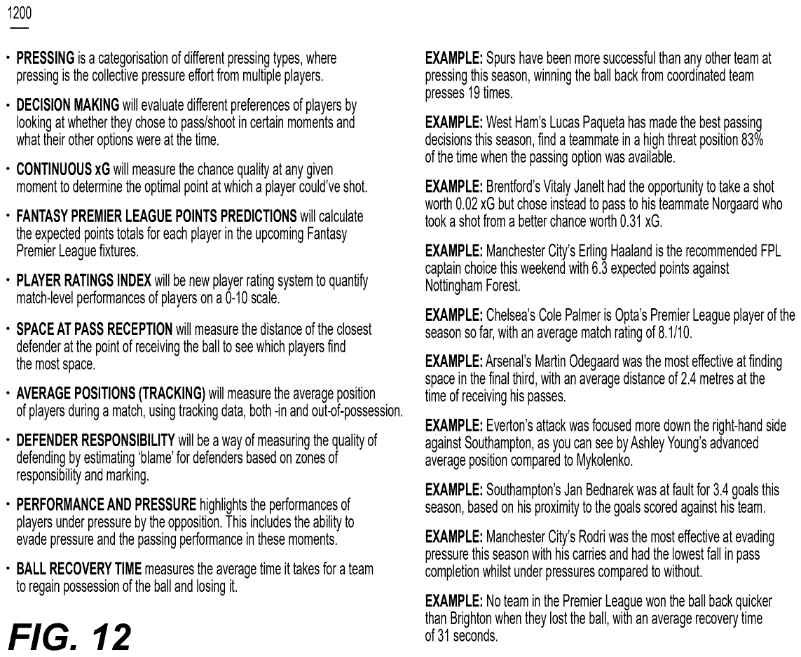

Referring now to FIG. 8, with respect to trait module 132, the output of step 810 comprises individual and/or team traits. FIGS. 11 and 12 have tables 1100, 1200 depicting exemplary trait definitions, according to example embodiments. Traits may be generated based on the broadcast tracking data 206, event data 208, and/or one or more trajectories for one or more agents, as described above. Traits may be used for agents and/or teams. For example, some traits may apply to both an agent and a team (e.g., decision making). Traits may include, for example, off-ball runs, phases of play, OPTA traits, marking, counter-pressing, overloads, team lines, pass predictions, pressing, decision making, continuous xG, fantasy premier league point predictions, player ratings index, space at pass reception, average positions, defender responsibility, performance under pressure, and ball recovery time.

Some traits (e.g., pass prediction, decision making, continuous xG) may be used by one or more machine-learning models to predict outcomes for an agent and/or a team. For example, the broadcast tracking data 206, event data 208, and/or one or more trajectories for one or more agents may include information relating to an option or availability to pass or shoot an object (e.g., a ball) at one or more points in time during a match. This information may be used to generate a pass prediction trait for an agent and/or a team. The pass prediction trait may be further used by one or more machine-learning models to predict a pass versus shot in a future scenario based on the aggregated information for the agent and/or team. This information may be used to generate graphic and/or text information for broadcasters or individual users.

Another example of trait information may include performance under pressure. As similarly described above, broadcast tracking data 206, event data 208, and/or one or more trajectories for one or more agents relating to performance under pressure may be collected and/or aggregated. Once the trait (e.g., performance under pressure) has been generated, individual users may utilize this trait. For example, a coach may use this information in preparation for an upcoming match. The trait information may relate to one or more individuals on either team as a whole. Coaches may utilize this information to determine different match-ups or markings for an upcoming match as well as which players to use to optimize their chances throughout the match. In addition, individual end users (e.g., fans, fantasy players, etc.) may utilize this information to determine how to set their line-up for an upcoming match in their fantasy league.

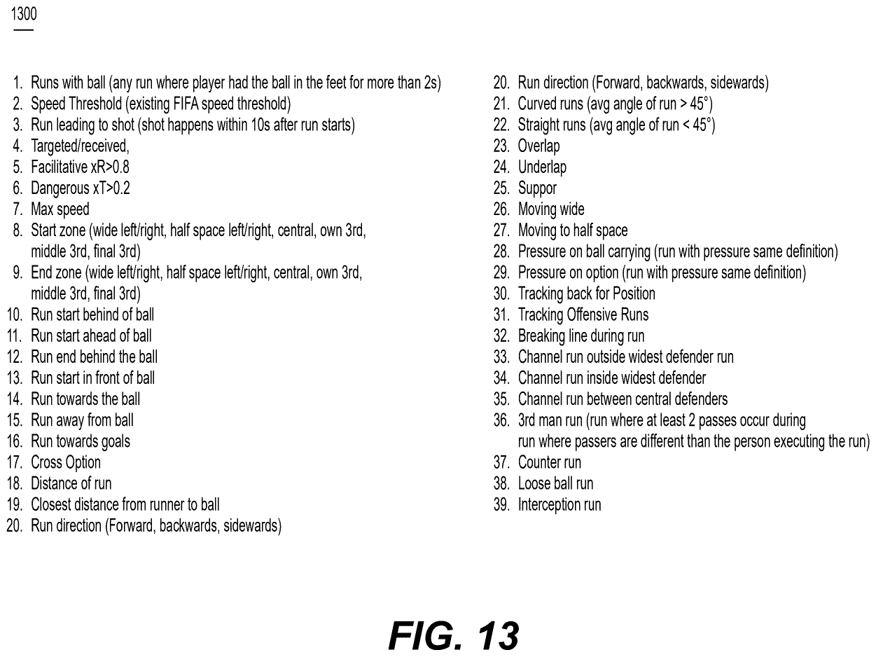

FIG. 13 depicts a table 1300 having a list of exemplary qualifiers, according to example embodiments. One or more qualifiers may be used to determine a specific trait using the broadcast tracking data 206, event data 208, and/or one or more trajectories for one or more agents. For example, a trait (e.g., off-ball runs) may be related to one or more qualifiers listed in FIG. 13. Player A, for example, may be associated with one or more trajectories that indicate that Player A runs away from the ball, runs towards a goal, overlaps, etc. Such qualifiers indicate that Player A has the off-ball runs trait.

In a further example, Player B may be associated with one or more trajectories that indicate that Player B pressures on ball carrying and pressures on option. Such qualifiers indicate that Player B has the pressing trait. In yet a further example, Team A may be associated with one or more trajectories that indicate that Team A has a particular end zone and channel runs with defenders. Such qualifiers indicate that Team A has the team lines trait. It is appreciated that the list of qualifiers is limited, and that additional qualifiers may be considered.

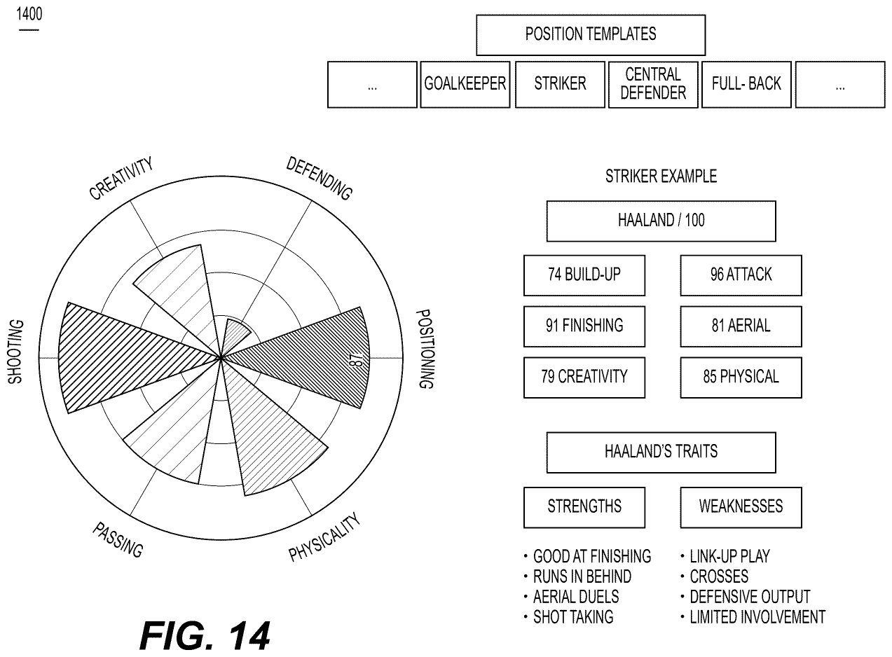

FIG. 14 depicts the use of traits to provide an index score for an individual player (e.g., Haaland) using, for example, both offensive and defensive traits. For example, the index score may include position themes and traits. Position themes may include build-up play, finishing, creativity, attacking, aerial ability, and physical. Traits may include good at finishing, shot taking, etc. The information may be aggregated to determine an index score for each of the themes and traits as described above. The index score for each player may be given based on a numerical scale of 0-100, but other types (e.g., alphanumeric) or the like may be used. Each of the index score may be accompanied by a graphic 1400 to display the overall index score of the individual player. The graphic 1400 may include one or more categories accompanied by a color and/or shape identifying each category and their respective score. Additional graphics may be used in place of or in addition to the graphic 1400 as displayed in FIG. 14.

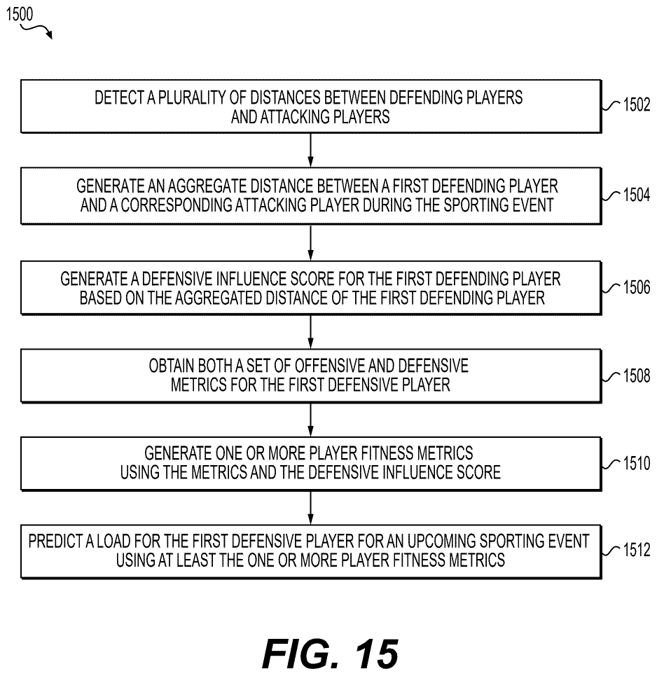

Referring now to FIG. 8, with respect to fitness module 134, step 810 further comprises steps described in FIG. 15. FIG. 15 depicts an example flowchart 1500 for generating a defensive influence score that quantifies a defensive intensity of a player during the course of a sporting event. At step 1502, based on the broadcast tracking data 206, event data 208, and/or one or more trajectories for one or more agents, the fitness module 134 may detect a plurality of distances between defending players and corresponding attacking players. At step 1504, the fitness module 134 can generate an aggregated distance between a first defending player and a corresponding attacking player during the sporting event. The aggregated distance can be indicative of an average distance the first defending player is from the attacking player during the course of the game. In some instances, the aggregated distance can be separated by time such that the distance can be tracked based on a time the player plays during the course of the game.

At step 1506, the fitness module 134 can generate a defensive influence score for the defending player based on the aggregated distance of the defending player. The defensive influence score can include a 0-100 score specifying a relative intensity of the defending player during the course of the game. In some instances, the defensive influence score comprises both an aggregate defensive influence score for the defensive player during an entirety of, for example, a basketball game, and a set of defensive influence scores for each of a set of time ranges in which the defending player played during the basketball game.

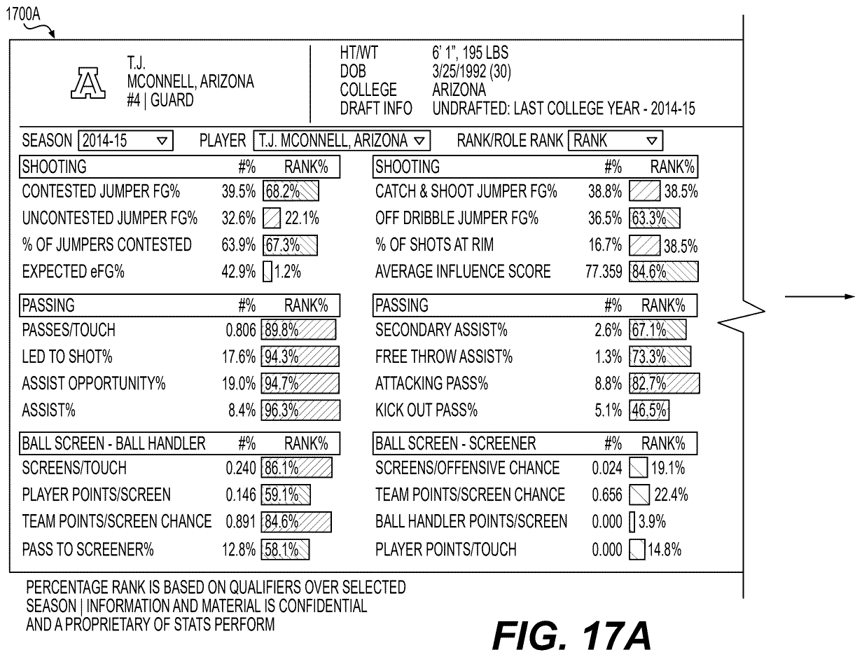

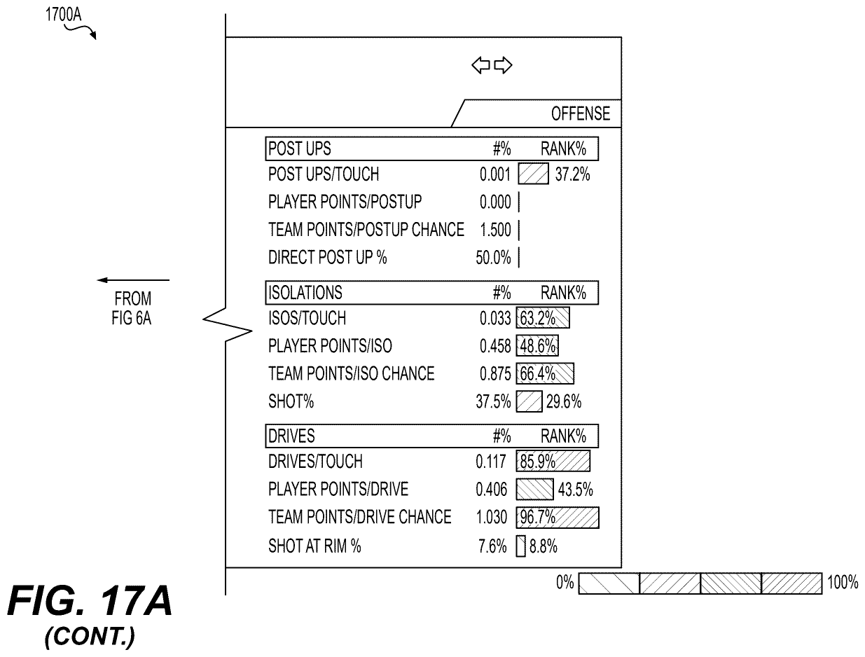

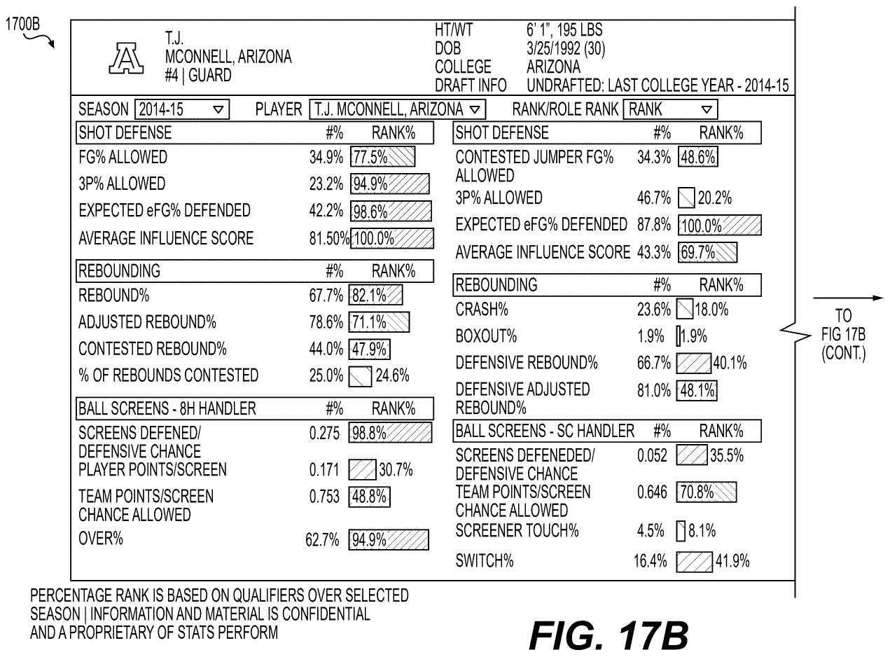

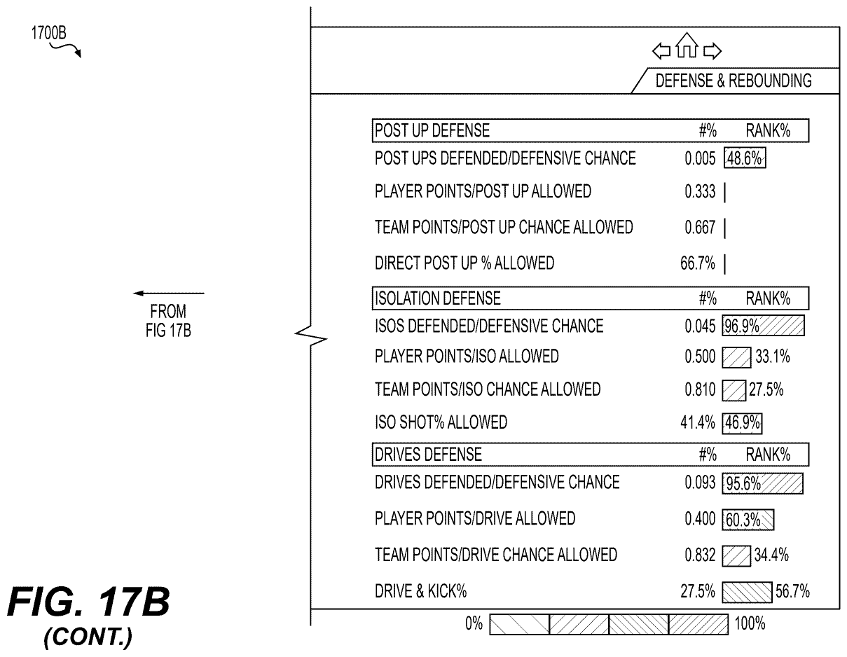

At step 1508, the fitness module 134 can obtain both a set of offensive and defensive metrics for the defensive player. Examples of the offensive metrics and defensive metrics can be shown in FIGS. 17A-17B, respectfully. At step 1510, the fitness module 134 can generate one or more player fitness metrics using the metrics and the defensive influence score. At step 1512, the fitness module 134 can predict a load for the defensive player for an upcoming sporting event using at least the one or more player fitness metrics. The load can include any of a number of playing minutes for the defensive player and one or more predicted defensive statistics for the defensive player for the upcoming sporting event.

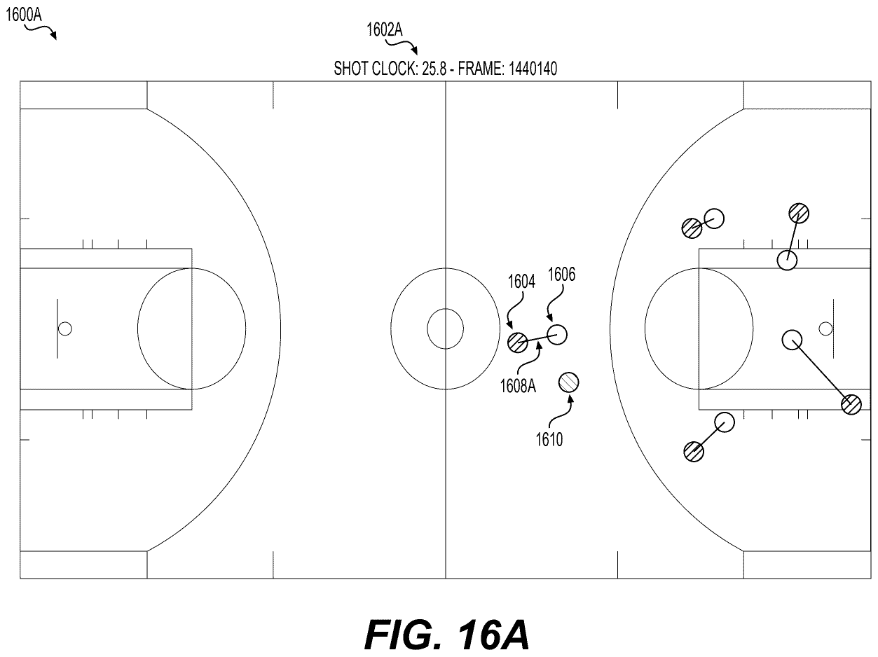

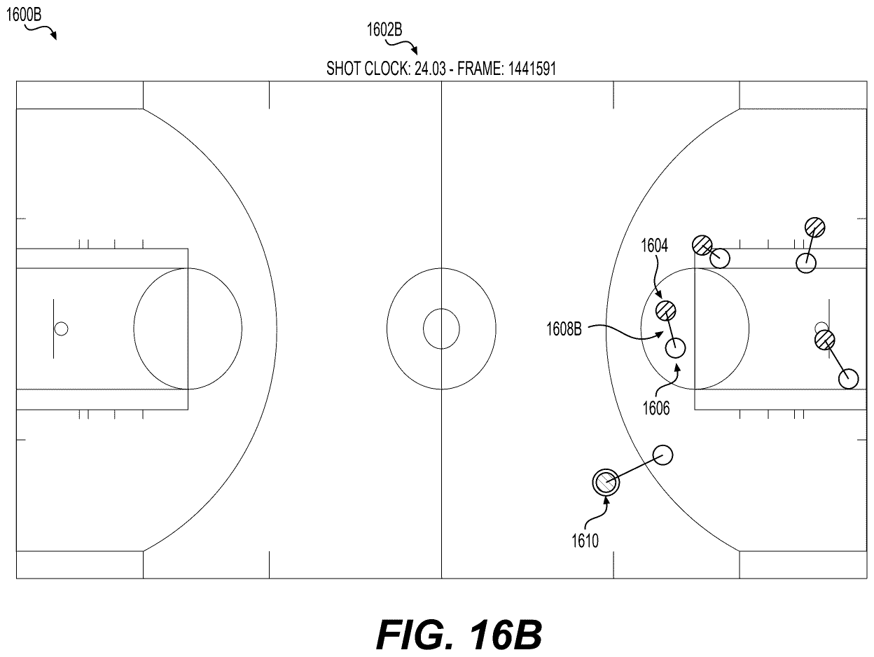

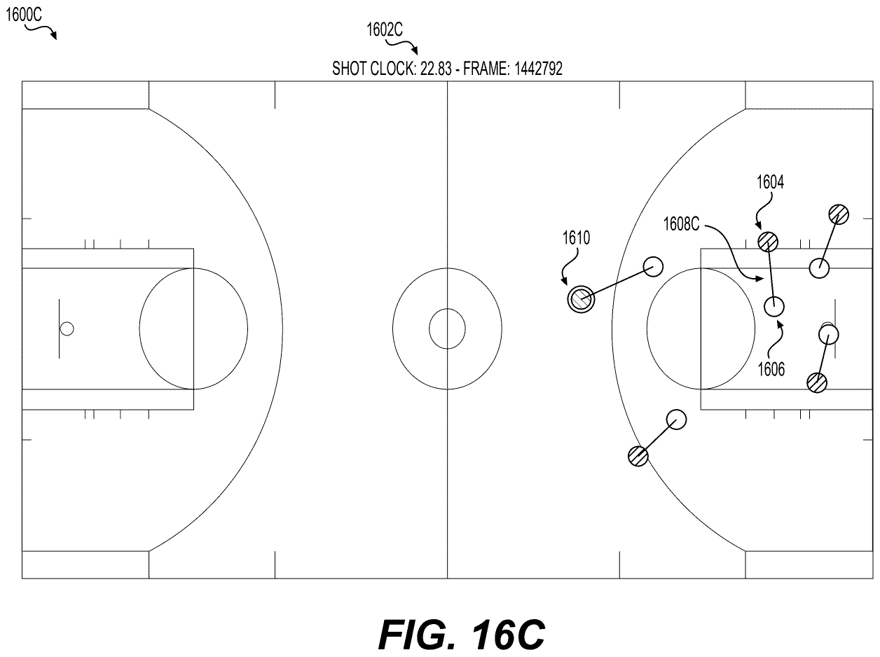

FIGS. 16A-C illustrate various frames of a virtual representation of a video broadcast of a basketball game, generated via the broadcast tracking data 206, event data 208, and/or one or more trajectories for one or more agents, according to example embodiments. Each frame 1600A-C as represented in FIGS. 16A-C can illustrate different frames of a video broadcast and different positions of players and the ball during the course of the game. As discussed herein, instead of a basketball game, the sporting event may be a soccer game, rugby game, American football game, and so forth.

FIG. 16A illustrates a first frame of a virtual representation of a video broadcast of a basketball game, according to example embodiments. For example, a first frame 1600A can depict a frame of the video broadcast, specified by a specific shot clock timeframe and a frame number (e.g., 1602A). Further, in FIG. 16A, each player can be specified as being part of either team (e.g., a team on offense, a team on defense), such as a first offensive player 1604 and a first defensive player 1606. A distance 1608A can be tracked between each defensive player and a corresponding offensive player being guarded. The distances between players can differ between players, positions, etc. Further, the distance a player keeps to an offensive player that the defender is guarding over the course of the game can be tracked to determine a defensive influence score of the player (e.g., player 1606) for each time duration during the game. Each frame can further track a location of the ball 1610 as the ball moves between possession of the players.

In some instances, the fitness module 134 (or some other module, e.g., prediction system 128) can track possession of the ball 1610 for either team. Further, the module 134 can determine when possession changes to the defending team. In such instances, once possession changes, the fitness module 134 can stop tracking distances (e.g., 1608A-C), as the first defensive player (e.g., player 1606) is now on offense. In some instances, distances may only start being tracked once the ball 1610 crosses a half-court line.

FIG. 16B illustrates a second frame of a virtual representation of a video broadcast of a basketball game, according to example embodiments. In FIG. 16B, a second frame 1600B (as shown by a unique frame number 1602B), the ball 1610 can be moved to a second offensive player, while the distance 1608B between the first offensive player 1604 and first defensive player 1606 can dynamically change as the players 1604, 1606 move across the court. In some instances, as the player (e.g., player 1606) changes guard to another player, the video remote tracking model can change the distance (e.g., 1608B) to between the defensive player and a new offensive player.

FIG. 16C illustrates a third frame of a virtual representation of a video broadcast of a basketball game, according to example embodiments. In FIG. 16C, the third frame 1600C (with unique frame number 1602C) can have the distance 1608C between player 1604, 1606 increase, which, when aggregated across multiple frames, can be indicative of a defensive intensity (represented in a defensive influence rating) for the player (e.g., player 1606) going downwards. The distances between defending players can be tracked for each frame and aggregated in generating defensive influence ratings as described herein.

FIGS. 17A-B illustrate example player cards 1700A-B illustrating various offensive and defensive metrics of the player generated by the fitness module 134, according to example embodiments. The player cards 1700A-B can summarize a series of metrics for the player. For example, offensive metrics (e.g., shown in FIG. 17A) can include shooting metrics, passing metrics, isolation metrics, ball screen metrics, etc. Defensive metrics (e.g., shown in FIG. 17B) can include shot defense metrics, rebounding metrics, isolation defense metrics, ball screen defense, etc. The player cards 1700A-B can illustrate values, percentages, etc., along with a rank for the player in each metric. The rank for each metric can provide a relative ranking of the player across other players in a similar league, or across all players of a same position, for example.

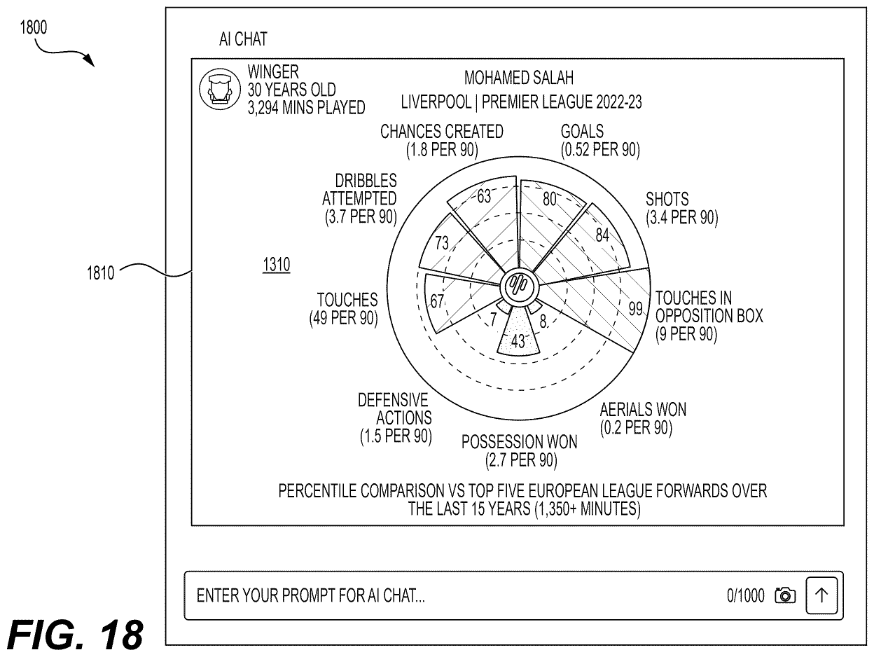

Referring now to FIG. 8, with respect to graphics module 136, the output of step 810 comprises graphics (e.g., pictures, videos, animations, etc.). FIG. 18 depicts an example graphic output interface, according to one or more embodiments. User interface 1800 may provide an exemplary graphic 1810 generated in conjunction with the mapping module 130 (e.g., via a user query). The graphic 1810 may correspond to the one or more inputted queries by the user. The exemplary graphic 1810 may include one or more of text, graphics, audio, video, or the like to convey the information requested by the user through the one or more queries. For example, the user may input text or audio as a user query. Based on the information determined by the system, a soccer generative model may be selected, as discussed herein. User interface 1800 may display graphic 1810 depicting analytic data (generated, for example, by the fitness module 134) corresponding to a soccer player that was the subject of the user query.

The system may further be configured to generate a textual description of the received broadcast data and labeled event data. This may, for example, be performed by a second machine learning system. Specifically, the second machine learning system may be configured to generate a textual description associated with the one or more players and/or teams corresponding to the user input. The textual description may be based on the one or more trajectories of the one or more agents. For example, where a trajectory of Player A intersects with a trajectory of Player B, the second machine learning system may generate a textual description that Player A collided with Player B.

The system may further determine a sequence of past events from the sporting event, the sequences corresponding to one or more plays in the sporting event. This may include identifying the start and end of a scoring play, a shot on goal, a key pass, etc. For example, this may be implemented by solely utilizing event data as input and then generating the full tracking data of all the players in order to generate a realistic looking play via, for example, graphics module 136. (i.e., text converted to video, where the event data is the text and the video is the complete tracking data).

Further examples of outputs may include what formation/shape a team is in, and what role each player is in at each fame; the passing options (xT, xP and xR); the pressure of each pass that the defender has put the passer under; the types of runs a player makes (i.e., active runs); if a pass has made a line-breaking pass; set-play analysis (is a team defending zonal or man-marking); ghosting (where players should have been; visual search-searching plays based on the trajectories of players. Each of these may be determined as an output based on the one or more trajectory sequences for the one or more agents.

The output of step 810 may further include, determining, one or more alternative trajectory sequences for the one or more agents, the one or more alternative trajectory being trajectories of highest predicted success for the one or more agents (also referred to as a “ghosting type output”). This may involve implementing the model described herein, where the training data was based on historical data indicating good, average, and bad locations of individuals on a sporting field, and outputting simulated movements based on the training data. The highest chance of success may refer to higher probability of completing a pass or highest probability of scoring a goal. The system may further determine what a particular team should have performed (e.g., a formation change or substitution).

In some cases, the received broadcast data and/or the labeled event data may include incomplete data. Incomplete data may mean that the model is unaware of relevant information, so the model may be configured to approximate the missing data. The model may approximate missing information efficiently. However if the missing information is of an outlier scenario, then the model may likely determine that the average behavior occurred and potentially miss the outlier or interesting behaviors. This may include stretches of the sporting event that are not broadcast or events that occur but are not correctly received as labeled event data. The sporting event may, for example, be a soccer match, football game, hockey game, a basketball game, baseball game, cricket match, rugby match, tennis match, individual sport game, team sport game, and/or the like.

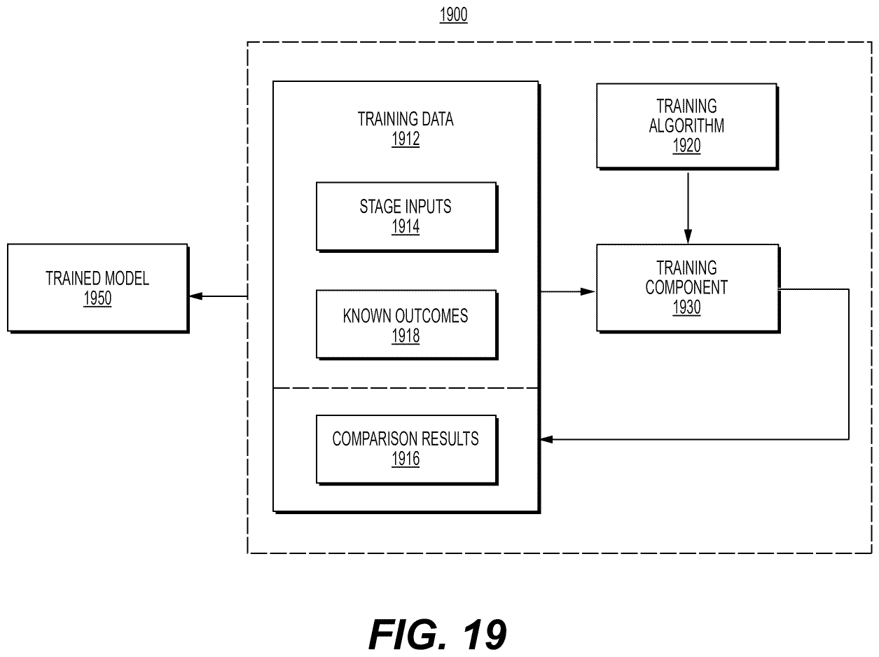

FIG. 19 depicts a flow diagram for training a machine learning model, in accordance with an aspect. As shown in flow diagram 1910 of FIG. 19, training data 1912 may include one or more of stage inputs 1914 and known outcomes 1918 related to a machine learning model to be trained. The stage inputs 1914 may be from any applicable source including a component or set shown in the figures provided herein. The known outcomes 1918 may be included for machine learning models generated based on supervised or semi-supervised training. An unsupervised machine learning model might not be trained using known outcomes 1918. Known outcomes 1918 may include known or desired outputs for future inputs similar to or in the same category as stage inputs 1914 that do not have corresponding known outputs.

The training data 1912 and a training algorithm 1920 may be provided to a training component 1930 that may apply the training data 1912 to the training algorithm 1920 to generate a trained machine learning model 1950. According to an implementation, the training component 1930 may be provided comparison results 1916 that compare a previous output of the corresponding machine learning model to apply the previous result to re-train the machine learning model. The comparison results 1916 may be used by the training component 1930 to update the corresponding machine learning model. The training algorithm 1920 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1910 may be a trained machine learning model 1950.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

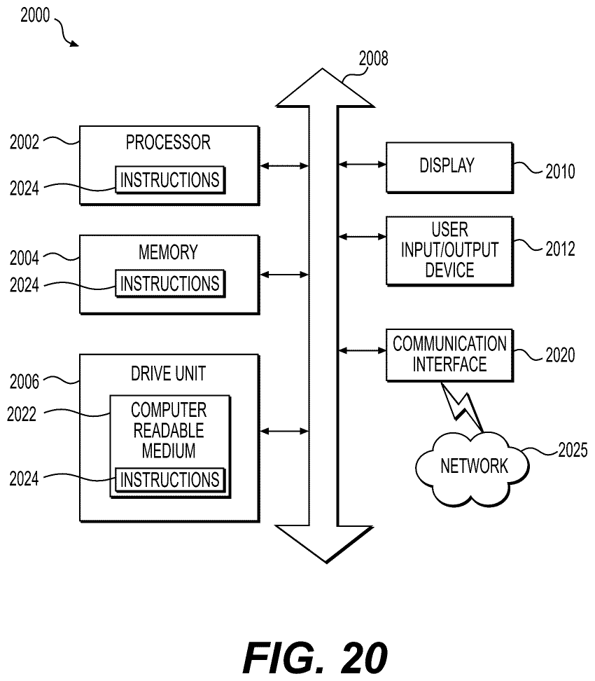

FIG. 20 is a simplified functional block diagram of a computer 2000 that may be configured as a device for executing the methods disclosed here, according to exemplary aspects of the present disclosure. For example, the computer 2000 may be configured as a system according to exemplary aspects of this disclosure. In various aspects, any of the systems herein may be a computer 2000 including, for example, a data communication interface 2020 for packet data communication. The computer 2000 also may include a central processing unit (“CPU”) 2002, in the form of one or more processors, for executing program instructions. The computer 2000 may include an internal communication bus 2008, and a storage unit 2006 (such as ROM, HDD, SDD, etc.) that may store data on a computer readable medium 2022, although the computer 2000 may receive programming and data via network communications 2025.

The computer 2000 may also have a memory 2004 (such as RAM) storing instructions 2024 for executing techniques presented herein, for example the methods described with respect to FIG. 8, although the instructions 2024 may be stored temporarily or permanently within other modules of computer 2000 (e.g., processor 2002 and/or computer readable medium 2022). The computer 2000 also may include input and output ports 2012 and/or a display 2010 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer implemented method for tracking one or more individuals during a sporting event, the method comprising:
receiving, as an input, broadcast tracking data of a sporting event and labeled event data of the sporting event;
performing multi-object tracking of one or more agents of the broadcast tracking data to determine one or more vectors;
inputting the labeled event data and one or more vectors into a diffusion model;
determining, using the diffusion model, one or more trajectory sequences for the one or more agents; and
determining, an output, based on the one or more trajectory sequences for the one or more agents.

2. The method of claim 1, further including:
determining, a sequence of past events from the sporting event, the sequences corresponding to one or more plays in the sporting event.

3. The method of claim 1, further including:
determining, one or more alternative trajectory sequences for the one or more agents, the one or more alternative trajectory being trajectories of highest predicted success for the one or more agents.

4. The method of claim 1, further including:
generating, with a second machine learning model, a textual description of the broadcast tracking data and the labeled event data.

5. The method of claim 1, wherein the broadcast tracking data and/or the labeled event data includes incomplete data of the sporting event.

6. The method of claim 1, wherein the sporting event is soccer, football, or hockey.

7. A system for tracking one or more individuals during a sporting event, the system comprising:
a non-transitory computer readable medium configured to store processor-readable instructions; and
a processor operatively connected to the non-transitory computer readable medium, and configured to execute the instructions to perform operations comprising:
receiving, as an input, broadcast tracking data of a sporting event and labeled event data of the sporting event;
performing multi-object tracking of one or more agents of the received broadcast tracking data to determine one or more vectors;
inputting the labeled event data and one or more vectors into a diffusion model;
determining, using the diffusion model, one or more trajectory sequences for the one or more agents; and
determining, an output, based on the one or more trajectory sequences for the one or more agents.

8. The system of claim 7, further including:
determining, a sequence of past events from the sporting event, the sequences corresponding to one or more plays in the sporting event.

9. The system of claim 7, further including:
determining, one or more alternative trajectory sequences for the one or more agents, the one or more alternative trajectory being trajectories of highest predicted success for the one or more agents.

10. The system of claim 7, further including:
generating, with a second machine learning model, a textual description of the broadcast tracking data and the labeled event data.

11. The system of claim 7, wherein the broadcast tracking data and/or the labeled event data includes incomplete data of the sporting event.

12. The system of claim 7, wherein the sporting event is soccer, football, or hockey.

13. A non-transitory computer readable medium configured to store processor-readable instructions, wherein when executed by a processor, the instructions perform operations comprising:
receiving, as an input, broadcast tracking data of a sporting event and labeled event data of the sporting event;
performing multi-object tracking of one or more agents of the received broadcast tracking data to determine one or more vectors;
inputting the labeled event data and one or more vectors into a diffusion model;
determining, using the diffusion model, one or more trajectory sequences for the one or more agents; and
determining, an output, based on the one or more trajectory sequences for the one or more agents.

14. The non-transitory computer readable medium of claim 13, further including:
determining, a sequence of past events from the sporting event, the sequences corresponding to one or more plays in the sporting event.

15. The non-transitory computer readable medium of claim 13, further including:
determining, one or more alternative trajectory sequences for the one or more agents, the one or more alternative trajectory being trajectories of highest predicted success for the one or more agents.

16. The non-transitory computer readable medium of claim 15, wherein the one or more alternative trajectories, being a respective trajectory with a highest percentage chance of a particular play in the sporting event ending with a goal.

17. The non-transitory computer readable medium of claim 13, further including:
generating, with a second machine learning model, a textual description of the broadcast tracking data and the labeled event data.

18. The non-transitory computer readable medium of claim 13, wherein the broadcast tracking data and/or the labeled event data includes incomplete data of the sporting event.

19. The non-transitory computer readable medium of claim 13, wherein the sporting event is soccer, football, or hockey.

20. The non-transitory computer readable medium of claim 13, further including:
determining one or more fitness outputs for the one or more agents, the one or more fitness outputs each indicating how far a player has run throughout the sporting event.
